(19) United States
(12) Patent Application Publication
(10) Pub. No.: US 2026/0032525 A1
(43) Pub. Date: Jan. 29, 2026

(54) User Equipment (UE) Selection of Candidate Cells to be Measured for L1/L2 Inter-Cell Mobility

(71) Applicant: Telefonaktiebolaget LM Ericsson (publ), Stockholm (SE)

(72) Inventors: Icaro Leonardo Da Silva, Solna (SE); Venkatarao Gonuguntla, Sundbyberg (SE); Claes Tidestav, Bålsta (SE); Antonino Orsino, Kirkkonummi (FI)

(21) Appl. No.: 18/997,635

(22) PCT Filed: Jul. 13, 2023
(86) PCT No.: PCT/SE2023/050734

§ 371 Date: Jan. 22, 2025

Related U.S. Application Data
(60) Provisional application No. 63/397,696, filed on Aug. 12, 2022.

(51) Int. Cl. H04W 36/00; H04B 17/318

(52) U.S. Cl. CPC H04W 36/0058; H04B 17/328

(57) ABSTRACT

Embodiments include methods for a user equipment (UE) configured to communicate with a radio access network (RAN) node via a serving cell. Such methods include obtaining a configuration that defines one or more conditions that trigger lower layer measurements on one or more candidate cells for L1/L2 inter-cell mobility. Such methods include performing one or more of the following measurements: lower layer measurements of the serving cell, first L3 measurements of the serving cell, and second L3 measurements of at least one of the candidate cells. Such methods include, based on detecting that the performed measurements fulfil at least one of the conditions, initiating lower layer measurements of at least one candidate cell associated with the fulfilled at least one condition, and sending to the RAN node a lower layer measurement report that includes results of the lower layer measurements performed on the at least one candidate cell.

### TECHNICAL FIELD

The present application relates generally to the field of wireless networks, and more specifically to improving mobility of user equipment (UEs) across multiple cells in a wireless network, specifically mobility based on layer-1 (L1) and/or layer-2 (L2) procedures that incur less delay than conventional layer-3 mobility procedures.

### INTRODUCTION

Currently the fifth generation (5G) of cellular systems is being standardized within the Third-Generation Partnership Project (3GPP). 5G is developed for maximum flexibility to support multiple and varied use cases that include enhanced mobile broadband (eMBB), machine type communications (MTC), ultra-reliable low latency communications (URLLC), and side-link device-to-device (D2D) communications, among others.

FIG. 1 illustrates a high-level view of an exemplary 5G network architecture, consisting of a Next Generation Radio Access Network (NG-RAN, 199) and a 5G Core (5GC, 198). The NG-RAN can include one or more gNodeB's (gNBs) connected to the 5GC via one or more NG interfaces, such as gNBs (100, 150) connected via respective interfaces (102, 152). More specifically, the gNBs can be connected to one or more Access and Mobility Management Functions (AMFs) in the 5GC via respective NG-C interfaces and to one or more User Plane Functions (UPFs) in 5GC via respective NG-U interfaces. The 5GC can include various other network functions (NFs), such as Session Management Function(s) (SMF).

Although not shown, in some deployments the 5GC can be replaced by an Evolved Packet Core (EPC), which conventionally has been used together with a Long-Term Evolution (LTE) Evolved UMTS RAN (E-UTRAN). In such deployments, gNBs (e.g., 100, 150) can connect to one or more Mobility Management Entities (MMEs) in EPC 198 via respective S1-C interfaces. Similarly, gNBs can connect to one or more Serving Gateways (SGWs) in EPC via respective NG-U interfaces.

In addition, the gNBs can be connected to each other via one or more Xn interfaces, such as Xn interface (140) between gNBs (100, 150). The radio technology for the NG-RAN is often referred to as “New Radio” (NR). With respect to the NR interface to UEs, each of the gNBs can support frequency division duplexing (FDD), time division duplexing (TDD), or a combination thereof. Each of the gNBs can serve a geographic coverage area including one or more cells.

The NG-RAN is layered into a Radio Network Layer (RNL) and a Transport Network Layer (TNL). The NG-RAN architecture, i.e., the NG-RAN logical nodes and interfaces between them, is defined as part of the RNL. For each NG-RAN interface (NG, Xn, F1) the related TNL protocol and the functionality are specified. The TNL provides services for user plane transport and signaling transport.

The NG RAN logical nodes shown in FIG. 1 include a Central Unit (CU or gNB-CU, e.g., 110) and one or more Distributed Units (DU or gNB-DU, e.g., 120, 130). CUs are logical nodes that host higher-layer protocols and perform various gNB functions such controlling the operation of DUs. DUs are decentralized logical nodes that host lower layer protocols and can include, depending on the functional split option, various subsets of the gNB functions. As such, each of the CUs and DUs can include various circuitry needed to perform their respective functions, including processing circuitry, communication interface circuitry (e.g., transceivers), and power supply circuitry.

A gNB-CU connects to one or more gNB-DUs over respective F1 logical interfaces (e.g., 122 and 132 shown in FIG. 1). However, a gNB-DU can be connected to only a single gNB-CU. The gNB-CU and its connected gNB-DU(s) are only visible to other gNBs and the 5GC as a gNB. In other words, the F1 interface is not visible beyond gNB-CU.

In addition to providing coverage via cells as in LTE, NR networks also provide coverage via “beams.” In general, a downlink (DL, i.e., network to UE) “beam” is a coverage area of a network-transmitted reference signal (RS) that may be measured or monitored by a UE. To support beam management, a UE can be configured with a Channel State Information (CSI) measurement configuration, which instructs the UE to monitor CSI-RS and to send various CSI reports to the RAN (e.g., NG-RAN). For example, the RAN indicates an explicit list of CSI resources to be monitored by the UE for each type of CSI report the UE is configured to send.

Similar techniques can be used for beam management based on synchronization signal/PBCH block (SSB) RS transmitted by the network. 3GPP Rel-17 includes an inter-cell beam management feature wherein the UE can have multiple active transmission configuration indicator (TCI) states, including one associated with the physical cell identity (PCI) of its serving cell and up to M other TCI states associated with PCIs of other cells. For example, the different PCIs can represent different transmission reception points (TRPs). For each of the N additional TCI states, the UE can be configured with CSI resources (or resource sets) to monitor for inter-PCI (or inter-cell) beam management.

As specified in 3GPP document RP-213565, NR Rel-18 includes a Work Item on NR mobility enhancements, including in the technical area of L1/L2 based inter-cell mobility. When the UE moves between the coverage areas of two cells, a serving cell change needs to be performed at some point. Currently, serving cell change is triggered by layer 3 (L3, e.g., RRC) measurements and involves radio resource control (RRC) signaling to change PCell and/or PSCell (e.g., when dual connectivity is configured), as well as to release/add SCells (e.g., when CA is configured).

Currently, L3 inter-cell mobility involves complete layer 2 (L2) and layer 1 (L1, i.e., PHY) resets, leading to longer latency, increased signaling overhead, and longer interruptions than for intra-cell beam switching. Thus, a goal of Rel-18 L1/L2 mobility enhancements is to facilitate serving cell change via L1/L2 signaling to address these problems and/or difficulties.

### SUMMARY

According to Rel-17, a UE can be configured with CSI resources to monitor in up to N=7 additional PCIs/TCI states for inter-cell beam management. Due to complexity constraints, however, a UE may be only capable of monitoring CSI resources in a subset M<N of the configured TCI states of other PCIs. This can cause various problems, issues, and/or difficulties for the UE and the RAN. Moreover, it is expected that these problems, issues, and/or difficulties will become more pronounced for Rel-18, since the UE may need to measure a greater number of other (e.g., neighbor) beams/cells to support L1/L2 inter-cell mobility.

An object of embodiments of the present disclosure is to address these and related problems, issues, and/or difficulties, thereby facilitating UE inter-cell beam management and L1/L2 mobility between cells in a RAN (e.g., NG-RAN).

Some embodiments of the present disclosure include methods (e.g., procedures) for a UE configured to communicate with a RAN node via a serving cell.

These exemplary methods include obtaining a configuration that defines one or more conditions that trigger lower layer measurements on one or more candidate cells for L1/L2 inter-cell mobility. These exemplary methods include performing one or more of the following measurements: lower layer measurements of the serving cell, first layer-3 (L3) measurements of the serving cell, and second L3 measurements of at least one of the candidate cells. These exemplary methods include, based on detecting that the performed measurements fulfil at least one of the conditions, initiating lower layer measurements of at least one candidate cell associated with the fulfilled at least one condition. These exemplary methods include sending to the RAN node a lower layer measurement report that includes results of the lower layer measurements performed on the at least one candidate cell.

In some embodiments, detecting that the performed measurements fulfil at least one of the conditions detecting one or more of the following:
results of the lower layer measurements of the serving cell are below a first threshold;
results of the L3 measurements of the serving cell are below a second threshold;
results of the L3 measurements of a candidate cell are below a third threshold;
results of the L3 measurements of a candidate cell are at least an offset greater than results of the L3 measurements of the serving cell;
results of the L3 measurements of the serving cell are below a fourth threshold; and
one or more highest of a plurality of lower layer measurements of the serving cell are below a seventh threshold.

In some of these embodiments, the plurality of lower layer measurements of the serving cell are measurements of a plurality of beams associated with the serving cell. In other of these embodiments, the offset is associated with a radio resource management (RRM) A3 event and/or the second threshold is an S-Measure RRM threshold.

In some embodiments, the exemplary method can also include stopping or pausing the lower layer measurements of the at least one candidate cell based on detecting that at least one of the following measurements fulfils a further one or more of the conditions:
the lower layer measurements of the at least one candidate cell,
the lower layer measurements of the serving cell,
the first L3 measurements of the serving cell, and
the second L3 measurements of the at least one of the candidate cell

In some of these embodiments, detecting that at least one the measurement fulfils a further one or more of the conditions includes detecting any of the following:
results of the L3 measurements of the serving cell are above a fifth threshold;
results of the L3 measurements of the at least one candidate cell are below a sixth threshold;
one or more highest of a plurality of lower layer measurements of the serving cell are above an eighth threshold; and
one or more highest of a plurality of lower layer measurements of the at least one candidate cell are below a ninth threshold.
   In some variants, the plurality of lower layer measurements of the at least one candidate cell (e.g., evaluated in relation to the ninth threshold) are measurements of a plurality of beams associated with the at least one candidate cell.

In some embodiments, the lower layer measurements of the serving cell and of the at least one candidate cell include one or more of the following: synchronization signal/PBCH (SSB) reference signal received power (SS-RSRP), SSB reference signal received quality (SS-RSRQ), SSB signal-to-noise and interference ratio (SS-SINR), channel state information (CSI) reference signal received power (CSI-RSRP), CSI reference signal received quality (CSI-RSRQ), CSI signal-to-noise and interference ratio (CSI-SINR), L1-RSRP, L1-RSRQ, and L1-SINR.

In some embodiments, one or more of the following applies: the L3 measurements of the serving cell and of the at least one candidate cell are L3 reference signal received power (L3-RSRP) measurements; and the L3 measurements of the serving cell and of the at least one candidate cell are associated with L3 inter-cell mobility procedures (e.g., handover).

In some embodiments, the one or more candidate cells for L1/L2 inter-cell mobility include a plurality of candidate cells. In such embodiments, detecting that the performed measurements fulfil at least one of the conditions includes determining that a plurality of the candidate cell are associated with the fulfilled at least one condition. Also, initiating lower layer measurements of at least one candidate cell associated with the fulfilled at least one condition selecting a subset of the plurality of candidate cells based on results of the respective second L3 measurements of the plurality of candidate cells. In such case, the lower layer measurements are initiated for the selected subset.

In some embodiments, the lower layer measurement report is a beam measurement report and/or the lower layer measurement report is sent via lower layer procedures on a PUCCH or a PUSCH in the serving cell.

In some embodiments, obtaining the configuration includes receiving from the RAN node a message that includes the configuration or a portion thereof. In some of these embodiments, the message is an RRCReconfiguration message. In some embodiments, the configuration or a portion thereof is obtained from UE memory.

In some embodiments, these exemplary methods can also include receiving from the RAN node a lower layer message instructing the UE to perform an L1/L2 inter-cell mobility procedure to one of the candidate cells for which measurement results were included in the lower layer measurement report. Based on the lower layer message, the UE can perform the L1/L2 inter-cell mobility procedure.

Other embodiments include methods (e.g., procedures) for a RAN node configured to provide a serving cell to UEs.

These exemplary methods include sending, to a UE, a configuration that defines one or more conditions that trigger lower layer measurements on one or more candidate cells for L1/L2 inter-cell mobility. The conditions are based on one or more of the following: lower layer measurements of the serving cell, first L3 measurements of the serving cell, and second L3 measurements of at least one of the candidate cells. These exemplary methods also receiving from the UE a lower layer measurement report that includes results of the lower layer measurements performed on the at least one candidate cell, based on fulfilment of at least one of the conditions.

In various embodiments, the conditions can include any of the corresponding conditions summarized above for UE embodiments. In various embodiments, the lower layer measurements of the serving cell and of the at least one candidate cell can include any of the corresponding lower layer measurements summarized above for UE embodiments.

In some embodiments, these exemplary methods can also include, based on the lower layer measurement report, selecting one of the candidate cells for an L1/L2 inter-cell mobility procedure for the UE and sending to the UE a lower layer message instructing the UE to perform the L1/L2 inter-cell mobility procedure to the selected candidate cell.

Other embodiments include UEs (e.g., wireless devices) and RAN nodes (e.g., base stations, eNBs, gNBs, ng-eNBs, etc. or components thereof such as CUs/DUs) configured to perform operations corresponding to any of the exemplary methods described herein. Other embodiments also include non-transitory, computer-readable media storing computer-executable instructions that, when executed by processing circuitry, configure such UEs and RAN nodes to perform operations corresponding to any of the exemplary methods described herein.

These and other embodiments described herein can provide various technical benefits and/or advantages. For example, compared to conventional techniques in which UEs autonomously select a subset M<N of configured candidate cells for measuring and reporting, embodiments enable the UE to systematically select a subset of candidate cells that is optimal and/or preferred at any given time. In this manner, lower layer measurements reported by the UE are better and/or more relevant for beam management and/or L1/L2 inter-cell mobility, while avoiding excessive UE energy consumption due to unnecessary measurements. At a high level, embodiments can improve UE mobility in RANs.

These and other objects, features, and advantages of the present disclosure will become apparent upon reading the following Detailed Description in view of the Drawings briefly described below.

### BRIEF DESCRIPTION OF THE DRAWINGS

FIG. 1 shows a high-level view of an exemplary 5G network architecture.

FIG. 2 shows an exemplary configuration of NR UP and CP protocol stacks.

FIGS. 3-4 show logical architectures for a gNB arranged in the split CU/DU architecture illustrated by FIG. 1.

FIG. 5 shows an exemplary ASN.1 data structure for an RRC CSI-MeasConfig information element (IE) used to configure CSI-RS resources for UE monitoring.

FIG. 6 shows an exemplary ASN.1 data structure for an RRC CSI-ReportConfig IE used to configure a UE for CSI reporting.

FIG. 7 shows an exemplary ASN.1 data structure of an RRC CSI-SSB-ResourceSet IE.

FIG. 8 shows an exemplary method (e.g., procedure) for a UE according to various embodiments of the present disclosure.

FIG. 9 shows an exemplary method (e.g., procedure) for a RAN node according to various embodiments of the present disclosure.

FIG. 10 shows a communication system according to various embodiments of the present disclosure.

FIG. 11 shows a UE according to various embodiments of the present disclosure.

FIG. 12 shows a network node according to various embodiments of the present disclosure.

FIG. 13 shows host computing system according to various embodiments of the present disclosure.

FIG. 14 is a block diagram of a virtualization environment in which functions implemented by some embodiments of the present disclosure may be virtualized.

FIG. 15 illustrates communication between a host computing system, a network node, and a UE via multiple connections, at least one of which is wireless, according to various embodiments of the present disclosure.

### DETAILED DESCRIPTION

Embodiments briefly summarized above will now be described more fully with reference to the accompanying drawings. These descriptions are provided by way of example to explain the subject matter to those skilled in the art and should not be construed as limiting the scope of the subject matter to only the embodiments described herein. More specifically, examples are provided below that illustrate the operation of various embodiments according to the advantages discussed above.

In general, all terms used herein are to be interpreted according to their ordinary meaning to a person of ordinary skill in the relevant technical field, unless a different meaning is expressly defined and/or implied from the context of use. All references to a/an/the element, apparatus, component, means, step, etc. are to be interpreted openly as referring to at least one instance of the element, apparatus, component, means, step, etc., unless explicitly stated otherwise or clearly implied from the context of use. The operations of any methods and/or procedures disclosed herein do not have to be performed in the exact order disclosed, unless an operation is explicitly described as following or preceding another operation and/or where it is implicit that an operation must follow or precede another operation. Any feature of any embodiment disclosed herein can apply to any other disclosed embodiment, as appropriate. Likewise, any advantage of any embodiment described herein can apply to any other disclosed embodiment, as appropriate.

Furthermore, the following terms are used throughout the description given below:
Radio Access Node: As used herein, a “radio access node” (or equivalently “radio network node,” “radio access network node,” or “RAN node”) can be any node in a radio access network (RAN) that operates to wirelessly transmit and/or receive signals. Some examples of a radio access node include, but are not limited to, a base station (e.g., gNB in a 3GPP 5G/NR network or an enhanced or eNB in a 3GPP LTE network), base station distributed components (e.g., CU and DU), a high-power or macro base station, a low-power base station (e.g., micro, pico, femto, or home base station, or the like), an integrated access backhaul (IAB) node, a transmission point (TP), a transmission reception point (TRP), a remote radio unit (RRU or RRH), and a relay node.
Core Network Node: As used herein, a “core network node” is any type of node in a core network. Some examples of a core network node include, e.g., a Mobility Management Entity (MME), a serving gateway (SGW), a PDN Gateway (P-GW), a Policy and Charging Rules Function (PCRF), an access and mobility management function (AMF), a session management function (SMF), a user plane function (UPF), a Charging Function (CHF), a Policy Control Function (PCF), an Authentication Server Function (AUSF), a location management function (LMF), or the like.
Wireless Device: As used herein, a “wireless device” (or “WD” for short) is any type of device that is capable, configured, arranged and/or operable to communicate wirelessly with network nodes and/or other wireless devices. Communicating wirelessly can involve transmitting and/or receiving wireless signals using electromagnetic waves, radio waves, infrared waves, and/or other types of signals suitable for conveying information through air. Unless otherwise noted, the term “wireless device” is used interchangeably herein with the term “user equipment” (or “UE” for short), with both of these terms having a different meaning than the term “network node”.
Radio Node: As used herein, a “radio node” can be either a “radio access node” (or equivalent term) or a “wireless device.”
Network Node: As used herein, a “network node” is any node that is either part of the radio access network (e.g., a radio access node or equivalent term) or of the core network (e.g., a core network node discussed above) of a cellular communications network. Functionally, a network node is equipment capable, configured, arranged, and/or operable to communicate directly or indirectly with a wireless device and/or with other network nodes or equipment in the cellular communications network, to enable and/or provide wireless access to the wireless device, and/or to perform other functions (e.g., administration) in the cellular communications network.
Node: As used herein, the term “node” (without prefix) can be any type of node that can in or with a wireless network (including RAN and/or core network), including a radio access node (or equivalent term), core network node, or wireless device. However, the term “node” may be limited to a particular type (e.g., radio access node, IAB node) based on its specific characteristics in any given context.

The above definitions are not meant to be exclusive. In other words, various ones of the above terms may be explained and/or described elsewhere in the present disclosure using the same or similar terminology. Nevertheless, to the extent that such other explanations and/or descriptions conflict with the above definitions, the above definitions should control.

Note that the description given herein focuses on a 3GPP cellular communications system and, as such, 3GPP terminology or terminology similar to 3GPP terminology is generally used. However, the concepts disclosed herein are not limited to a 3GPP system, and can be applied in any system that can benefit from the concepts, principles, and/or embodiments described herein.

FIG. 2 shows an exemplary configuration of NR user plane (UP) and control plane (CP) protocol stacks between a UE (210), a gNB (220), and an AMF (230). The Physical (PHY), Medium Access Control (MAC), Radio Link Control (RLC), and Packet Data Convergence Protocol (PDCP) layers between the UE and the gNB are common to UP and CP. The PDCP layer provides ciphering/deciphering, integrity protection, sequence numbering, reordering, and duplicate detection for both CP and UP. In addition, PDCP provides header compression and retransmission for UP data.

On the UP side, Internet protocol (IP) packets arrive to the PDCP layer as service data units (SDUs), and PDCP creates protocol data units (PDUs) to deliver to RLC. The Service Data Adaptation Protocol (SDAP) layer handles quality-of-service (QoS) including mapping between QoS flows and Data Radio Bearers (DRBs) and marking QoS flow identifiers (QFI) in UL and DL packets. RLC transfers PDCP PDUs to MAC through logical channels (LCH). RLC provides error detection/correction, concatenation, segmentation/reassembly, sequence numbering, reordering of data transferred to/from the upper layers. MAC provides mapping between LCHs and PHY transport channels, LCH prioritization, multiplexing into or demultiplexing from transport blocks (TBs), hybrid ARQ (HARQ) error correction, and dynamic scheduling (on gNB side). PHY provides transport channel services to MAC and handles transfer over the NR radio interface, e.g., via modulation, coding, antenna mapping, and beam forming.

On the CP side, the non-access stratum (NAS) layer is between UE and AMF and handles UE/gNB authentication, mobility management, and security control. RRC sits below NAS in the UE but terminates in the gNB rather than the AMF. RRC controls communications between UE and gNB at the radio interface as well as the mobility of a UE between cells in the NG-RAN. RRC also broadcasts system information (SI) and performs establishment, configuration, maintenance, and release of DRBs and Signaling Radio Bearers (SRBs) and used by UEs. Additionally, RRC controls addition, modification, and release of carrier aggregation (CA) and dual-connectivity (DC) configurations for UEs, and performs various security functions such as key management.

After a UE is powered ON it will be in the RRC_IDLE state until an RRC connection is established with the network, at which time the UE will transition to RRC CON-NECTED state (e.g., where data transfer can occur). The UE must perform a random-access (RA) procedure to move from RRC_IDLE to RRC_CONNECTED state, where the cell serving the UE is known and an RRC context is established for the UE in the serving gNB, such that the UE and gNB can communicate. As part of (or in conjunction with) the RA procedure, the UE also transmits an RRCSetupRequest message to the serving gNB.

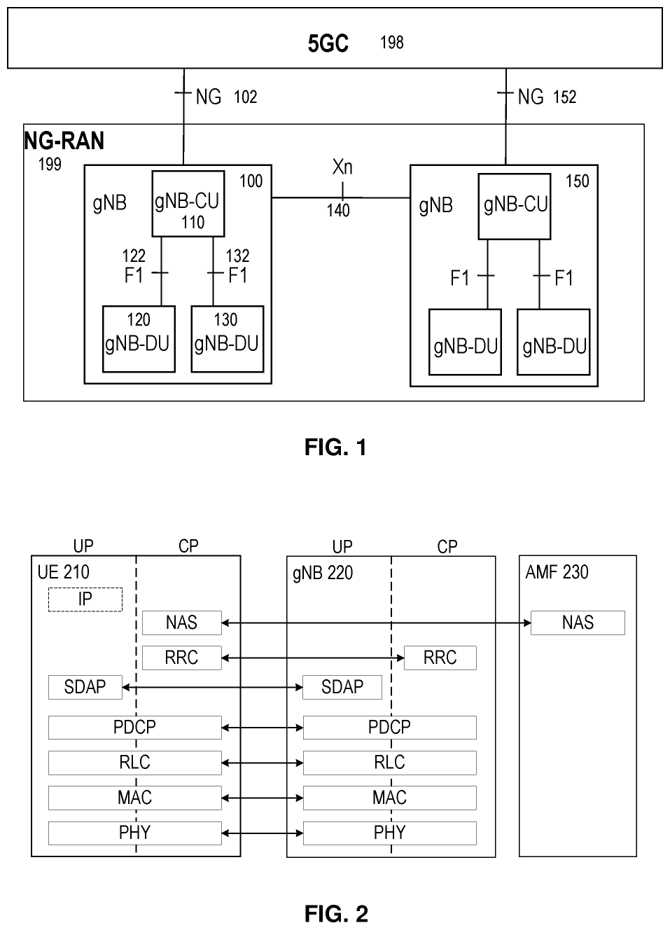

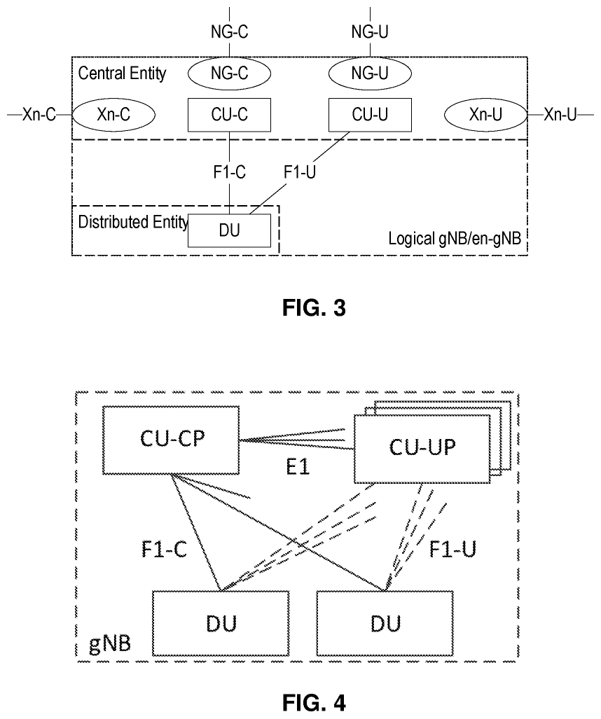

FIG. 3 shows a logical architecture for a gNB arranged in the split CU/DU architecture, such as gNB 100 in FIG. 1. This logical architecture separates the CU into CP and UP functionality, called CU-C and CU-U respectively. Furthermore, each of the NG, Xn, and F1 interfaces is split into a CP interface (e.g., NG-C) and a UP interface (e.g., NG-U). Note that the terms “Central Entity” and “Distributed Entity” in FIG. 3 refer to physical network nodes.

FIG. 4 shows another exemplary gNB logical architecture that includes two gNB-DUs, a gNB-CU-CP, and multiple gNB-CU-UPs. The gNB-CU-CP may be connected to the gNB-DU through the F1-C interface, and the gNB-CU-UP may be connected to the gNB-DU through the F1-U interface and to the gNB-CU-CP through the E1 interface. Each gNB-DU may be connected to only one gNB-CU-CP, and each gNB-CU-UP may be connected to only one gNB-CU-CP. One gNB-DU may be connected to multiple gNB-CU-UPs under the control of the same gNB-CU-CP. Also, one gNB-CU-UP may be connected to multiple DUs under the control of the same gNB-CU-CP. When referring herein to an operation performed by a “CU”, it should be understood that this operation can be performed by any entities within the CU (e.g., CU-CP, gNB-CU-CP) unless stated otherwise.

As briefly mentioned above, to support beam management, a UE can be configured with a Channel State Information (CSI) measurement configuration, which instructs the UE to monitor CSI-RS and to send various CSI reports to the NG-RAN. For example, the NG-RAN indicates an explicit list of CSI resources to be monitored by the UE for each type of CSI report the UE is configured to send. In the split-gNB architecture, the UE is configured by and sends the CSI reports to the DU that provides the UE's serving cell. Similar techniques can be used for beam management based on SSB transmitted by the DU in the serving cell.

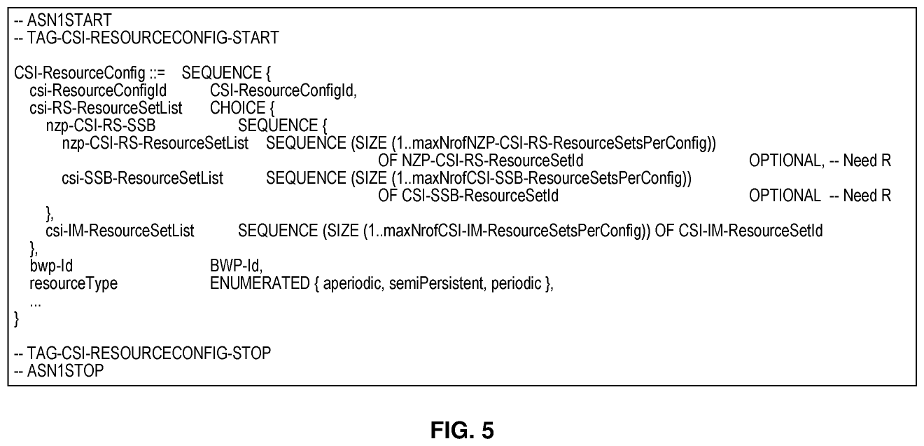

FIG. 5 shows an exemplary ASN.1 data structure for an RRC CSI-MeasConfig information element (IE) used to configure RS resources for UE to monitor/measure for CSI reporting. This IE is configured per UE serving cell, within a ServingCellConfig IE, which associates serving cell and corresponding CSI reports. For each type of CSI report the UE needs to transmit, the network indicates an explicit list of CSI resources to monitor in the nzp-CSI-RS-ResourceSetList field shown in FIG. 5. The network can provide a list of up to maxNrofNZP-CSI-RS-ResourceSetsPerConfig CSI resource sets for each of the UE's serving cells, including the UE's PCell/SpCell and any configured SCells. Table 1 below further defines certain fields included in the data structure shown in FIG. 5.

TABLE 1

| Field name | Description |
|---|---|
| bwp-Id | The DL BWP which the CSI-RS |
| | associated with this CSI- |
| | ResourceConfig are located in. |
| csi-IM-ResourceSetList | List of references to CSI-IM |
| | resources used for CSI |
| | measurement and reporting in a |
| | CSI-RS resource set. Contains |
| | up to maxNrofCSI-IM- |
| | ResourceSetsPerConfig |
| | resource sets if resourceType |
| | is ‘aperiodic’ and 1 |
| | otherwise. |
| csi-ResourceConfigId | Used in CSI-ReportConfig to |
| | refer to an instance of |
| | CSI-ResourceConfig. |
| csi-SSB-ResourceSetList | List of references to SSB |
| | resources used for CSI |
| | measurement and reporting |
| | in a CSI-RS resource set. |
| nzp-CSI-RS-ResourceSetList | List of references to NZP |
| | CSI-RS resources used for |
| | beam measurement and reporting |
| | in a CSI-RS resource set. |
| | Contains up to maxNrofNZP- |
| | CSI-RS-ResourceSetsPerConfig |
| | resource sets if resourceType |
| | is ‘aperiodic’ and 1 |
| | otherwise. |
| resourceType | Time domain behavior of resource |
| | configuration. It does not |
| | apply to resources provided |
| | in the csi-SSB-ResourceSetList. |

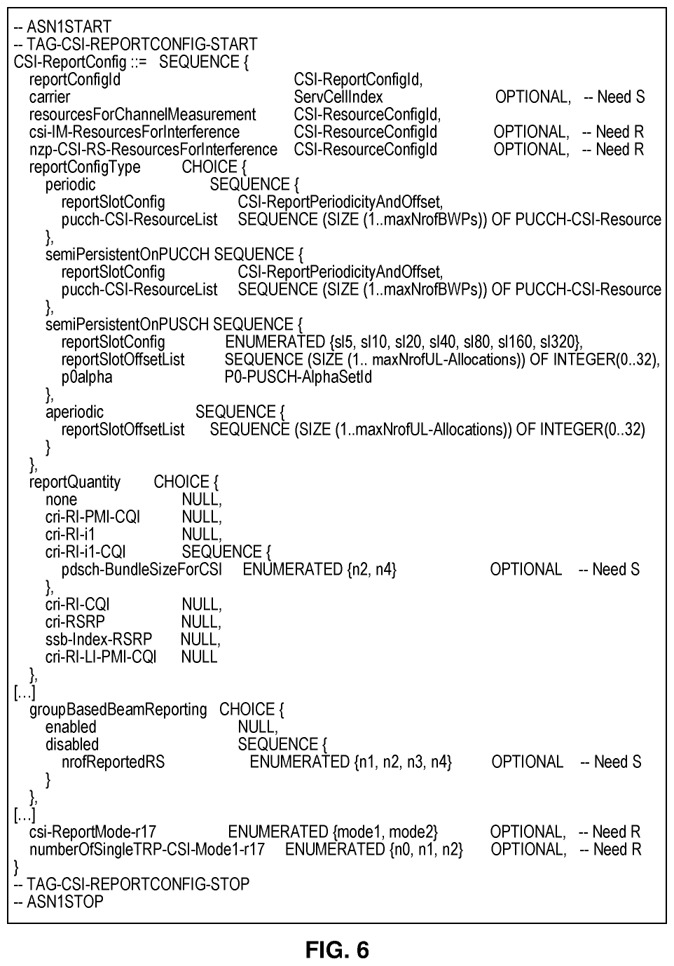

The RS resources configured for UE monitoring in this manner can also be associated with a CSI reporting configuration. FIG. 6 shows an exemplary ASN.1 data structure for an RRC CSI-ReportConfig IE used to configure a UE for CSI reporting. UE CSI reports configured in this manner can assist the RAN with beam management operations, such as beam switching, activation/deactivation of beams to transmit data and/or control channels to the UE, etc.

In 5G NR terminology, a beam may also be referred to as a Transmission Configuration Indication (TCI) state. Each TCI state includes parameters defining a quasi-co-location (QCL) relationship between one or more source DL reference signals (RS, e.g., SSB) and one or more other DL RS such as DM-RS ports of physical DL shared channel (PDSCH) or physical DL control channel (PDCCH) or channel state information RS (CSI-RS) ports of a DL CSI-RS resource. In general, different DL RS can have a QCL relationship when their respective antenna ports in the base station transmitter satisfy the condition that properties of a channel over which a symbol on one antenna port is conveyed can be inferred from the channel over which a symbol on the other antenna port is conveyed.

The CSI-ReportConfig IE in FIG. 6 can configure a periodic or semi-persistent CSI report to be sent on PUCCH in the cell in which the CSI-ReportConfig IE is included, or a semi-persistent or aperiodic CSI report sent on PUSCH triggered by downlink control information (DCI) received in the cell in which the CSI-ReportConfig IE is included (i.e., the cell on which the report is sent is determined by the received DCI). In particular, the field reportConfigType in FIG. 6 indicates the UL channel in which to transmit the report and the time domain reporting behavior (i.e., whether the report is periodic, aperiodic, or semi-persistent, as well as related parameters such as periodicity). 3GPP Rel-17 includes an inter-cell beam management feature wherein the UE can have multiple active TCI states (or beams), including one associated with the physical cell identity (PCI) of its serving cell and up to M other TCI states associated with PCIs of other cells. For example, the different PCIs can represent different transmission reception points (TRPs). For each of the N additional TCI states, the UE can be configured with RS resources (or resource sets) to monitor for inter-PCI (or inter-cell) beam management.

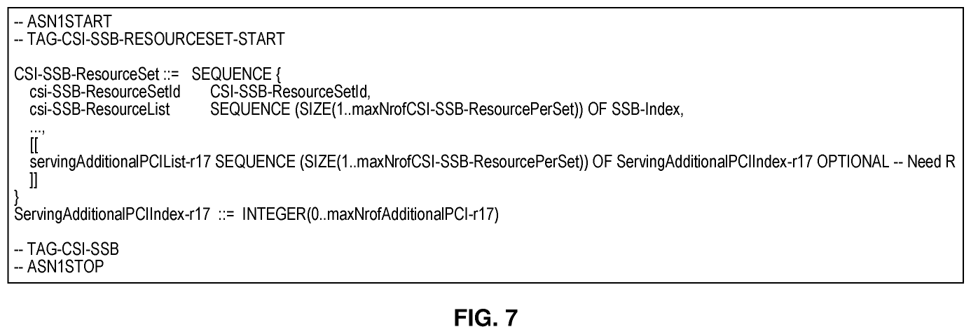

FIG. 7 shows an exemplary ASN.1 data structure for an RRC CSI-SSB-ResourceSet IE used to configure a UE for multi-PCI CSI monitoring. The field servingAdditionalPCIList Indicates the PCIs of the SSBs in the csi-SSB-ResourceList. If present, the list has the same number of entries as csi-SSB-ResourceList. The first entry of the list indicates the PCI value for the first entry of csi-SSB-ResourceList, the second entry of this list indicates the PCI value for the second entry of csi-SSB-ResourceList, etc. If the value of a list entry is zero, the PCI is the PCI of the serving cell in which this CSI-SSB-ResourceSet is defined. Otherwise, the value is additionalPCllndex-r17 of an SSB-MTC-AdditionalPCI-r17 sub-field in the additionalPCIList-r17 field of the ServingCellConfig IE (mentioned above), and the PCI is the content of additionalPCI-r17 field in this SSB-MTC-AdditionalPCI-r17 sub-field.

In general, time domain CSI reporting behavior for Rel-17 multi-TRP remains the same as in previous releases i.e., CSI reports may be period, aperiodic, or semi-persistent.

As specified in 3GPP document RP-213565, NR Rel-18 includes a Work Item on NR mobility enhancements, including in the technical area of L1/L2 based inter-cell mobility. When the UE moves between the coverage areas of two cells, a serving cell change needs to be performed at some point. Currently, serving cell change is triggered by layer 3 (L3, e.g., RRC) measurements and involves RRC signaling to change PCell and PSCell (e.g., when dual connectivity is configured), as well as release/add SCells (e.g., when CA is configured).

Currently, all inter-cell mobility involves complete layer 2 (L2) and layer 1 (L1, i.e., PHY) resets, leading to longer latency, increased signaling overhead, and longer interruptions than for intra-cell beam switching. Thus, a high-level goal of the Rel-18 L1/L2 mobility enhancements is to facilitate serving cell change via L1/L2 signaling to address these problems and/or difficulties. Some more specific goals include:
Configuration and maintenance for multiple candidate cells to allow fast application of configurations for candidate cells;
Dynamic switch mechanism among candidate serving cells (including SpCell and SCell) for the potential applicable scenarios based on L1/L2 signalling;
L1 enhancements for inter-cell beam management, including L1 measurement and reporting, and beam indication;
Timing Advance management; and
CU-DU interface signaling to support L1/L2 mobility, if needed.

These Rel-18 L1/L2 mobility enhancements also must consider the split CU/DU architecture shown in FIGS. 1 and 3-4, including for intra-DU and inter-DU/intra-CU cell changes. In the inter-DU/intra-CU scenario, the candidate cell for L1/L2 inter-cell mobility is a cell served by a neighbor DU to the (serving or source) DU that currently provides the UE's PCell (or PSCell, for SCG change in DC).

As briefly mentioned above, in Rel-17, for beam management of a serving cell (e.g., PCell and SCells of Master Cell Group). a UE can be configured with CSI resources to monitor in up to N=7 additional PCIs than the PCI associated with the serving cell. The value N corresponds to the maxNrofAdditionalPCI parameter in FIG. 7. Due to complexity constraints, however, a UE may be only capable of monitoring CSI resources in a subset M<N of the other PCIs. In fact, for Rel-17, a UE is only required to monitor CSI resources in M=1 of the other PCIs at any given time.

Since a UE monitors only the subset M of the N additional PCIs at any given time, the RAN may need to frequently reconfigure the CSI resource set to be monitored. This issue may be even worse with Rel-18, where the UE may need to be configured with more than N additional beams or cells for L1-L2 inter-cell mobility and/or inter-cell beam management. In such case, the RAN needs to perform multiple RRC reconfigurations to configure the UE with N (N>M) additional beams or cells, which increases RRC signaling overhead and processing requirements.

Furthermore, when a UE is configured with N candidate cells but is only capable of measuring a subset M<N at any given time, which subset M<N the UE should measure is not clear. In other words, it entirely up to UE implementation which M<7 of the N=7 configured additional PCIs the UE measures and reports to the RAN for L1-L2 inter-cell mobility and/or inter-cell beam management.

Even if Rel-18 requires a UE to measure multiple beams (e.g., SSBs) from multiple L1/L2 inter-cell mobility candidate cells concurrently to support L1/L2 inter-cell mobility, it is expected that this requirement will significantly increase UE energy consumption. Moreover, these measurements often may be unnecessary, such as when the beam of the serving cell used for transmitting control and data channels is in very good radio conditions, i.e., when the QCL source RS (e.g., SSB) of an activated TCI state is in very good radio conditions.

Furthermore, in general, CSI measurements may be more costly than RRM measurements from the UE perspective. This can be due to factors such as increased number of samples, greater accuracy requirements, and need to measure finer beams. Accordingly, the number of cells on which a UE can perform concurrent CSI measurements may be less than the number of cells on which a UE can perform concurrent RRM measurements.

Embodiments of the present disclosure address these and other problems, difficulties, and/or issues by providing flexible and efficient techniques for a UE configured with one or more L1/L2 inter-cell mobility candidate cells to limit the number of lower layer measurements (e.g., CSI measurements, L1 RSRP, SS-RSRP, etc.) on these L1/L2 inter-cell mobility candidate cells. Various embodiments include different events, triggers, and/or conditions for initiating lower layer measurements on one or more L1/L2 inter-cell mobility candidate cells, while the UE refrains from initiating such measurements while the relevant events, triggers, and/or conditions are not fulfilled.

Embodiments can be summarized as follows. Some embodiments include methods for a UE configured to communicate with a RAN node via a serving cell. The UE can receive from the RAN node a message (e.g., RRC message) including a configuration for lower layer (e.g., beam) measurements. The configuration includes one or more events, triggers, and/or thresholds (referred to generically as “conditions”) for initiating lower layer measurements on one or more first candidate cells (e.g., for L1/L2 inter-cell mobility). The one or more conditions can be based on results of measurements performed by the UE on the serving cell and/or a second candidate cell. When the UE detects the one or more conditions are fulfilled, the UE initiates lower layer measurements on the one or more first candidate cells and reports the results of these lower layer measurements to the RAN node (e.g., in a measurement report based on a reporting configuration previously received from the RAN node).

Other embodiments include methods for a RAN node configured to provide a serving cell to one or more UEs. The RAN node transmits to a UE a message (e.g., RRC message) including a configuration for lower layer (e.g., beam) measurements by the UE. The configuration includes one or more events, triggers, and/or thresholds (referred to generically as “conditions”) for initiating lower layer measurements on one or more first candidate cells (e.g., for L1/L2 inter-cell mobility). The one or more conditions can be based on results of measurements performed by the UE on the serving cell and/or a second candidate cell. Subsequently, the RAN node can receive from the UE results of lower layer measurements performed by the UE on the one or more first candidate cells based on fulfilment of the one or more conditions. For example, the lower layer measurement results can be received in a measurement report based on a reporting configuration previously sent to the UE.

Embodiments can provide various benefits and/or advantages. For example, compared to conventional techniques in which UEs autonomously select a subset M<N of configured candidate cells for measuring and reporting, embodiments enable the UE to systematically select a subset of candidate cells that is optimal and/or preferred at any given time. In this manner, the lower layer measurements reported by the UE are better and/or more relevant for beam management and/or L1/L2 inter-cell mobility, while avoiding excessive UE energy consumption due to unnecessary measurements. At a high level, embodiments can improve UE mobility in RANs.

In the present disclosure, the following terms may be used interchangeably: “L1/L2 based inter-cell mobility” (as used in the 3GPP Work Item), “L1/L2 mobility,” “L1-mobility,” “L1 based mobility,” “L1/L2-centric inter-cell mobility,” “L1/L2 inter-cell mobility,” “inter-cell beam management,” and “inter-DU L1/L2 based inter-cell mobility”. These terms refer to a scenario in which a UE receives lower layer (i.e., below L3/RRC, such as MAC or PHY) signaling from a network indicating for the UE to change of its serving cell (e.g., PCell) from a source cell to a target cell. Exemplary lower layer signaling includes L1 DL control information (DCI) and L2 MAC control element (CE). Compared to conventional RRC signaling, lower layer signaling reduces processing time and interruption time during mobility and may also increase mobility robustness since the network can respond more quickly to changes in the UE's channel conditions.

Another relevant aspect in L1/L2 inter-cell mobility is that a cell can be associated with multiple SSBs (or beams), with different SSBs being transmitted in different spatial directions during a half frame, thereby spanning the coverage area of a cell. A cell may also be associated with multiple CSI-RS resources, which may be transmitted in different spatial directions. Hence, in L1/L2 inter-cell mobility, the reception of lower layer signaling indicating for the UE to change from one beam in its serving cell to another beam in a (candidate) neighbor cell, which also involves changing serving cell.

In the present disclosure, the term “L1/L2 inter-cell mobility candidate cell” refers to a non-serving cell configured for a UE, to which the UE can perform an L1/L2 inter-cell mobility operation upon reception of lower layer signaling instructing the UE to do so. The terms “candidate cell,” “candidate,” “mobility candidate,” “non-serving cell,” and “additional cell” may be used interchangeably with L1/L2 inter-cell mobility candidate cell.” etc.

As such, when configured, a UE performs and reports results of lower layer measurements (e.g., CSI measurements) in a candidate cell, upon which the RAN may make mobility decisions such as selecting a beam (e.g., TCI state) and/or cell to switch the UE from a current serving cell/beam. A candidate cell may be a candidate for a primary cell (PCell) of a cell group or for a secondary cell (SCell) of a cell group, including a master cell group (MCG) or a secondary cell group (SCG). As such, configured RS resources for UE measurement and reporting may be for a candidate PCell or a candidate SCell of the MCG, or for a candidate PSCell or a candidate SCell of the SCG.

In the present disclosure, the term “CSI resource configuration” refers to a configuration of, for, and/or associated with one or more RS resources to be measured by the UE for CSI reporting, specifically resources of an L1/L2 inter-cell mobility candidate cell. A “resource” may be one or more SSB, one or more CSI-RS, etc. A configured resource may be associated with a particular candidate cell by any appropriate identifier, identity, index, etc. included in the CSI resource configuration.

In the present disclosure, the term “reference signal” (abbreviated as “RS”) includes any signals with a known content or pattern that can be measured by a UE, including but not limited to CSI-RS, DM-RS, synchronization signals (SS, e.g., SSB), etc.

In the present disclosure, the term “lower layer measurement” refers to a measurement performed at a lower layer (i.e., below L3/RRC, such as MAC or PHY) of a UE protocol stack on RS transmitted by a cell (“RS resources”). For example, if the measured RS are SSB, the lower layer measurement may be one or more of SSB reference signal received power (SS-RSRP), SSB reference signal received quality (SS-RSRQ), SSB signal-to-noise and interference ratio (SS-SINR), L1-RSRP, L1-RSRQ, and L1-SINR. Likewise, if the measured RS are CSI-RS, the lower layer measurement may be one or more of CSI reference signal received power (CSI-RSRP), CSI reference signal received quality (CSI-RSRQ), CSI signal-to-noise and interference ratio (CSI-SINR), L1-RSRP, L1-RSRQ, and L1-SINR. Other exemplary lower layer measurements based on RS include Channel Quality Indicator (CQI), precoding matrix indicator (PMI), CSI-RS resource indicator (CRI), SSB Resource indicator (SSBRI), Layer indicator (LI), and Rank indicator (RI).

The RS used for lower layer measurement may be transmitted in a certain spatial direction (e.g., beam) using a beamforming technique. Since a lower layer measurement is performed on a beam, it may be referred to as a “beam measurement.” In that sense, the lower layer measurement may indicate the quality of a beam that may serve the UE, e.g., before or after L1/L2 mobility. In general, a lower layer measurement may be reported to the RAN in any appropriate form (e.g., in a CSI report) that assists the RAN with decisions about L1/L2 inter-cell mobility or beam management for UEs, such as determining whether a UE needs to be switched to a beam (or TCI state) of a candidate cell in a L1/L2 inter-cell mobility procedure.

In the present context, a lower layer measurement is different than an RRM measurement reported in an RRC Measurement Report message defined in 3GPP TS 38.331. For example, an RRM measurement is configured by an RRC measurement configuration (MeasConfig IE in an RRCReconfiguration message), is L3 filtered, is used as input to trigger an RRC Measurement Report, and once reported, is typically used by the network (e.g., the CU) to determine whether the UE needs to be handed over to another cell or not, with an L3 (RRC) procedure called Reconfiguration with Sync. As such, the term “L3 measurement” may be used interchangeably with “RRM measurement” herein. L3 measurements may be performed on serving cells (e.g., PCell, PSCell, SCells) and/or candidate cells, including candidate cells for L1/L2 inter-cell mobility.

Some embodiments include methods for a UE configured to communicate with a RAN node via a serving cell. The UE can receive from the RAN node a message (e.g., RRC message) including a configuration for a lower layer (e.g., beam) measurement. The configuration includes (e.g., by defining) one or more events, triggers, and/or conditions (referred to generically as “conditions”) that trigger lower layer measurements on one or more candidate cells (e.g., for L1/L2 inter-cell mobility). The one or more conditions can be based on results of RRM or lower layer measurements performed on the serving cell and/or on results of RRM measurements performed on the candidate cells. When the UE detects the one or more conditions are fulfilled, the UE initiates lower layer measurements on the one or more candidate cells and reports the results of these lower layer measurements to the RAN node (e.g., in a measurement report based on a reporting configuration previously received from the RAN node).

In various embodiments, the one or more conditions can be based on or related to one or more of the following:
a lower layer measurement performed on a serving cell (e.g., PCell, PSCell, SCell), such as L1-RSRP) on the RS (e.g., SSB and/or CSI-RS) configured as QCL source of the active TCI state of the serving cell, or on a beam used for transmitting data and/or control channels in the serving cell;
an L3 measurement performed on a serving cell, such as L3-RSRP of a PCell based on SSB, L3-RSRP of the PCell based on CSI-RS, etc.
an L3 measurement performed on an L1/L2 inter-cell mobility candidate cell, such as L3-RSRP of the candidate cell based on SSB, L3-RSRP of the candidate cell based on CSI-RS, etc.

In various embodiments, the configured conditions may be applicable to an individual candidate cell (i.e., one set of conditions per candidate cell), to all candidate cells, or to a particular frequency (e.g., SSB frequency) of all candidate cells (i.e., one set of conditions per frequency).

In some embodiments, the configured conditions may be applicable to a single type of RS (e.g., SSB or CSI-RS) or to all types of RS (e.g., SSB and CSI-RS). In the former case, different conditions may be configured for each type of RS (e.g., first set for SSB, second set for CSI-RS, etc.).

In some embodiments, the configuration defining the one or more conditions may be a CSI measurement configuration (e.g., CSI-MeasConfig IE) or an RRC measurement configuration (e.g., MeasConfig IE). Alternately, some of the conditions may be defined by a configuration stored in UE memory. For example, a portion of the configuration may be included in the message while another portion of the configuration may be obtained from UE memory. In some embodiments, the message including the configuration (or portion thereof) may be an RRCReconfiguration message.

Some embodiments are described below based on example conditions.

In some embodiments, the UE initiates lower layer measurements on an L1/L2 inter-cell mobility candidate cell when lower layer measurements performed on a serving cell are below a first threshold.

For example, the UE initiates lower layer measurements on a candidate cell when SS-RSRP of an SSB used as QCL source of the activated TCI state of the serving cell (e.g., PCell) is below the first threshold. As a more specific example, if the SSB used as QCL source in the serving cell is at a first frequency (e.g., ARFCN), then the UE can initiate lower layer measurements on a candidate cell at the first frequency. Alternately, the UE can initiate lower layer measurements on a candidate cell at a second frequency different than the first frequency.

As another example, the UE performs lower layer measurements on all configured serving cells of a cell group (e.g., PCell and SCells of MCG, PSCell and SCells of SCG) but the condition for initiating lower layer measurements on L1/L2 inter-cell mobility candidate cells is that lower layer measurements for the PCell are below the first threshold. In any event, when the condition is triggered, the UE initiates lower layer measurements of candidate cells at the same frequencies as all cells in the cell group (e.g., frequencies of PCell and SCells of MCG).

In some embodiments, the UE initiates lower layer measurements on a L1/L2 inter-cell mobility candidate cell when RRM measurement performed on a serving cell is below a second threshold. As one example, the second threshold may correspond to an s-Measure threshold, which is conventionally used for measurements configured on the MCG. In these embodiments, the s-Measure threshold is also used as a condition for initiating lower layer measurements on L1/L2 inter-cell mobility candidate cells.

As a more specific example, when the UE's RRM measurements (e.g., RSRP) of the serving PCell is below the second threshold, the UE initiates RRM measurements on neighbor cells in frequencies identified in the RRC Measurement Configuration and initiates lower layer measurements on one or more configured L1/L2 inter-cell mobility candidate cells. In contrast, the UE does not initiate the RRM measurements on the neighbor cells or the lower layer measurements on the L1/L2 mobility candidate cells when the PCell RSRP is above s-Measure.

As another specific example, when the UE's RRM measurements (e.g., RSRP) of a serving cell at a frequency Fx are below the second threshold, the UE initiates lower layer measurements on one or more configured L1/L2 inter-cell mobility candidate cells at the same frequency Fx.

In some embodiments, the UE initiates lower layer measurements on an L1/L2 inter-cell mobility candidate cell when RRM measurements performed on an L1/L2 inter-cell mobility candidate cell are above a third threshold. In some variants, the candidate cell on which the lower layer measurements are initiate is the same candidate cell for which the RRM measurements exceeded the third threshold.

In one example, the UE performs RRM measurements (e.g., L3-RSRP) on an L1/L2 inter-cell mobility candidate cell. If measured L3-RSRP is above the third threshold, the UE initiates lower layer measurements on the L1/L2 inter-cell mobility candidate cell. In a variant, the second threshold discussed above can be used to initiate UE RRM measurements on the configured L1/L2 inter-cell mobility candidate cells. In contrast, the third threshold is used to initiate lower layer measurements on the L1/L2 inter-cell mobility candidate cells (which are more costly in processing and energy consumption than RRM measurements). In other words, the UE only performs lower layer measurements on L1/L2 inter-cell mobility candidate cells with good enough cell quality, such that the RAN is only informed about beams of candidate cells that are sufficient for L1/L2 inter-cell mobility.

In other embodiments, the UE initiates lower layer measurements on an L1/L2 inter-cell mobility candidate cell when RRM measurements performed on an L1/L2 inter-cell mobility candidate cell are at least an offset greater than RRM measurements of the UE's serving cell (e.g., PCell, PSCell, or SCell). This can be considered an RRM “A3 event”.

For example, the UE performs RRM measurements (e.g., RSRP based on SSB) on a L1/L2 inter-cell mobility candidate cell and a serving cell. If the candidate cell RSRP value is at least an offset greater than the RSRP value for the serving cell, the UE performs and reports lower layer measurements on the L1/L2 inter-cell mobility candidate cell. Conventionally, L3-based mobility (e.g., handover) is triggered in the RAN based on UE measurements associated with an A3-type event. By initiating performing and reporting of lower layer measurements based on the A3-type event, the UE will cause the RAN to trigger L1/L2 mobility instead of L3 mobility.

In some embodiments, the UE initiates lower layer measurements on an L1/L2 inter-cell mobility candidate cell when RRM measurements performed on the serving cell are below a fourth threshold.

In some embodiments, when the UE is configured with an s-Measure threshold in the RRC MeasConfig IE, the UE performs lower layer measurements on neighbor cells configured as L1/L2 inter-cell mobility candidates even if the PCell L3-RSRP is above the s-Measure threshold.

In some embodiments, the UE stops or pauses ongoing lower layer measurements on an L1/L2 inter-cell mobility candidate cell when RRM measurements performed on the serving cell are above a fifth threshold.

In some embodiments, the UE stops or pauses ongoing lower layer measurements on an L1/L2 inter-cell mobility candidate cell when RRM measurements performed on the candidate cell are below a sixth threshold. In some variants, the UE may initiate lower layer measurement on another candidate cell in conjunction with stopping or pausing the lower layer measurements in the candidate cell in this manner.

In some embodiments, the UE initiates lower layer measurements (e.g., beam measurements) on an L1/L2 inter-cell mobility candidate cell when one or more of the highest (or most favorable) lower layer measurement (e.g., beam measurements) in the serving cell are below a seventh threshold. As an example, this can occur when the strongest beam's L1-RSRP measurement is less than the seventh threshold. As another example, this can occur when L1-RSRP measurements for the K>1 strongest beams are less than the seventh threshold.

In some embodiments, the UE stops or pauses ongoing lower layer measurements on an L1/L2 inter-cell mobility candidate cell when one or more of the highest (or most favorable) lower layer measurement (e.g., beam measurements) in the candidate cell are above an eighth threshold. As an example, this can occur when the strongest beam's L1-RSRP measurement is greater than the eighth threshold. As another example, this can occur when L1-RSRP measurements for the K>1 strongest beams are greater than the eighth threshold.

In some embodiments, the UE stops or pauses ongoing lower layer measurements on an L1/L2 inter-cell mobility candidate cell when one or more of the highest (or most favorable) lower layer measurement (e.g., beam measurements) in the candidate cell are below a ninth threshold. As an example, this can occur when the strongest beam's L1-RSRP measurement is less than the ninth threshold. As another example, this can occur when L1-RSRP measurements for the K>1 strongest beams are less than the ninth threshold.

In some embodiments, when conditions are fulfilled to initiate measurements in P>1 candidate cells, the UE initiates measurements in a subset M<P of the candidate cells. The quantity M can be based on UE capabilities and UE performance requirements. The UE can select the subset M<P based on the respective L3 measurement results for the P candidate cells.

In some embodiments, the UE reports the results of the lower layer measurements in the candidate cell(s) to the RAN node in a lower layer measurement report, such as a beam measurement report. The lower layer measurement report can be sent via lower layer (e.g., PHY) procedures on a Physical Uplink Control Channel (PUCCH) or a Physical Uplink Shared Channel (PUSCH) in the serving cell. The lower layer measurement report can include a single measurement report in a single message or a plurality of measurement reports in a corresponding plurality of messages.

Other embodiments include methods for a RAN node configured to provide a serving cell to one or more UEs. The RAN node transmits to a UE a message (e.g., RRC message) including a configuration for lower layer (e.g., beam) measurements by the UE. The configuration includes one or more conditions for initiating lower layer measurements on one or more candidate cells (e.g., for L1/L2 inter-cell mobility). The one or more conditions can be based on results of RRM or lower layer measurements performed by the UE on the serving cell and/or on results of RRM measurements performed by the UE on the candidate cells, including any of the conditions discussed above in relation to UE embodiments.

Subsequently, the RAN node can receive from the UE results of lower layer measurements performed by the UE on the one or more candidate cells based on fulfilment of the one or more conditions. For example, the lower layer measurement results can be received in a lower layer measurement report based on a reporting configuration previously provided to the UE. Based on the lower layer measurement report, the RAN node can decide to initiate an L1/L2 inter-cell mobility procedure for the UE towards one of the candidate cells and sends to the UE a lower layer message instructing the UE to perform the L1/L2 inter-cell mobility procedure for the UE towards the selected candidate cell.

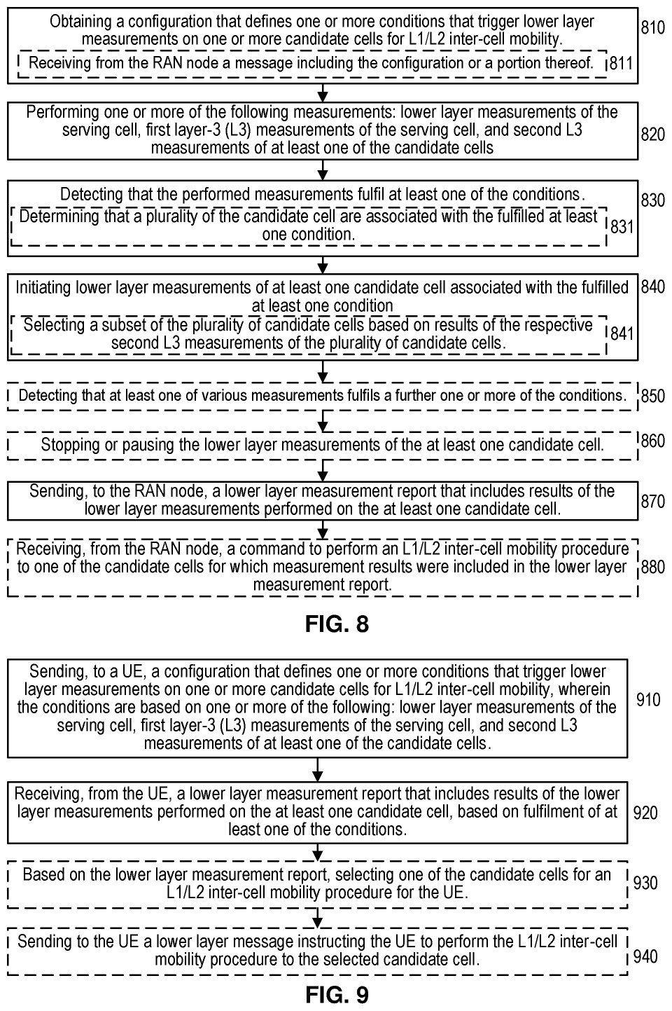

The embodiments described above can be further illustrated by reference to FIGS. 8-9, which depict exemplary methods (e.g., procedures) for a UE and a RAN node, respectively. Put differently, various features of the operations described below correspond to various embodiments described above. The exemplary methods shown in FIGS. 8-9 can be used cooperatively to provide benefits, advantages, and/or solutions to problems described herein. Although FIGS. 8-9 illustrate the exemplary methods by specific blocks in particular orders, the operations corresponding to the blocks can be performed in different orders than shown and can be combined and/or divided into blocks and/or operations having different functionality than shown. Optional blocks or operations are indicated by dashed lines.

More specifically, FIG. 8 illustrates an exemplary method (e.g., procedure) for a UE configured to communicate with a RAN node via a serving cell, according to various embodiments of the present disclosure. The exemplary method shown in FIG. 8 can be performed by a UE (e.g., wireless device) such as described elsewhere herein.

The exemplary method can include the operations of block 810, where the UE can obtain a configuration that defines one or more conditions that trigger lower layer measurements on one or more candidate cells for L1/L2 inter-cell mobility. The exemplary method can also include the operations of block 820, where the UE can perform one or more of the following measurements: lower layer measurements of the serving cell, first layer-3 (L3) measurements of the serving cell, and second L3 measurements of at least one of the candidate cells. The exemplary method can also include the operations of block 830-840, where based on detecting that the performed measurements fulfil at least one of the conditions, the UE can initiate lower layer measurements of at least one candidate cell associated with the fulfilled at least one condition. The exemplary method can also include the operations of block 870, where the UE can send to the RAN node a lower layer measurement report that includes results of the lower layer measurements performed on the at least one candidate cell.

In some embodiments, detecting that the performed measurements fulfill at least one of the conditions in block 830 includes detecting one or more of the following:
results of the lower layer measurements of the serving cell are below a first threshold;
results of the L3 measurements of the serving cell are below a second threshold;
results of the L3 measurements of a candidate cell are below a third threshold;
results of the L3 measurements of a candidate cell are at least an offset greater than
results of the L3 measurements of the serving cell;
results of the L3 measurements of the serving cell are below a fourth threshold; and
one or more highest of a plurality of lower layer measurements of the serving cell are below a seventh threshold.

In some of these embodiments, the plurality of lower layer measurements of the serving cell are measurements of a plurality of beams associated with the serving cell. In other of these embodiments, the offset is associated with a radio resource management (RRM) A3 event and/or the second threshold is an S-Measure RRM threshold.

In some embodiments, the exemplary method can also include the operations of blocks 850-860, where the UE can stop or pause the lower layer measurements of the at least one candidate cell based on detecting that at least one of the following measurements fulfills a further one or more of the conditions:
the lower layer measurements of the at least one candidate cell,
the lower layer measurements of the serving cell,
the first L3 measurements of the serving cell, and
the second L3 measurements of the at least one of the candidate cell

In some of these embodiments, detecting that at least one the measurement fulfills a further one or more of the conditions in block 850 includes detecting any of the following:
results of the L3 measurements of the serving cell are above a fifth threshold;
results of the L3 measurements of the at least one candidate cell are below a sixth threshold;
one or more highest of a plurality of lower layer measurements of the serving cell are above an eighth threshold; and
one or more highest of a plurality of lower layer measurements of the at least one candidate cell are below a ninth threshold.

In some variants, the plurality of lower layer measurements of the at least one candidate cell (e.g., evaluated in relation to the ninth threshold) are measurements of a plurality of beams associated with the at least one candidate cell.

In some embodiments, the lower layer measurements of the serving cell and of the at least one candidate cell include one or more of the following: synchronization signal/PBCH (SSB) reference signal received power (SS-RSRP), SSB reference signal received quality (SS-RSRQ), SSB signal-to-noise and interference ratio (SS-SINR), channel state information (CSI) reference signal received power (CSI-RSRP), CSI reference signal received quality (CSI-RSRQ), CSI signal-to-noise and interference ratio (CSI-SINR), L1-RSRP, L1-RSRQ, and L1-SINR.

In some embodiments, one or more of the following applies: the L3 measurements of the serving cell and of the at least one candidate cell are L3 reference signal received power (L3-RSRP) measurements; and the L3 measurements of the serving cell and of the at least one candidate cell are associated with L3 inter-cell mobility procedures (e.g., handover).

In some embodiments, the one or more candidate cells for L1/L2 inter-cell mobility include a plurality of candidate cells. In such embodiments, detecting that the performed measurements fulfil at least one of the conditions in block 830 includes the operations of sub-block 831, where the UE can determine that a plurality of the candidate cell are associated with the fulfilled at least one condition. Also, initiating lower layer measurements of at least one candidate cell associated with the fulfilled at least one condition in block 840 includes the operations of sub-block 841, where the UE can select a subset of the plurality of candidate cells based on results of the respective second L3 measurements of the plurality of candidate cells. In such case, the lower layer measurements are initiated for the selected subset.

In some embodiments, the lower layer measurement report is a beam measurement report and/or the lower layer measurement report is sent via lower layer procedures on a PUCCH or a PUSCH in the serving cell.

In some embodiments, obtaining the configuration in block 810 includes the operations of sub-block 811, where the UE can receive from the RAN node a message that includes the configuration or a portion thereof. In some of these embodiments, the message is an RRCReconfiguration message. In some embodiments, the configuration or a portion thereof is obtained from UE memory.

In some embodiments, the exemplary method can also include the operations of block 880, where the UE can receive from the RAN node a lower layer message instructing the UE to perform an L1/L2 inter-cell mobility procedure to one of the candidate cells for which measurement results were included in the lower layer measurement report. Based on the lower layer message, the UE can perform the L1/L2 inter-cell mobility procedure.

In addition, FIG. 9 illustrates an exemplary method (e.g., procedure) for a RAN node configured to provide a serving cell to one or more UEs, according to various embodiments of the present disclosure. The exemplary method shown in FIG. 9 can be performed by a CU such as described elsewhere herein.

The exemplary method can include the operations of block 910, where the RAN node can send, to a UE, a configuration that defines one or more conditions that trigger lower layer measurements on one or more candidate cells for L1/L2 inter-cell mobility. The conditions are based on one or more of the following: lower layer measurements of the serving cell, first layer-3 (L3) measurements of the serving cell, and second L3 measurements of at least one of the candidate cells. The exemplary method can also include the operations of block 920, where the RAN node can receive from the UE a lower layer measurement report that includes results of the lower layer measurements performed on the at least one candidate cell, based on fulfilment of at least one of the conditions.

In some embodiments, the conditions include one or more of the following:
results of the lower layer measurements of the serving cell are below a first threshold;
results of the L3 measurements of the serving cell are below a second threshold;
results of the L3 measurements of a candidate cell are below a third threshold;
results of the L3 measurements of a candidate cell are at least an offset greater than results of the L3 measurements of the serving cell;
results of the L3 measurements of the serving cell are below a fourth threshold; and
one or more highest of a plurality of lower layer measurements of the serving cell are below a seventh threshold.

In some of these embodiments, the plurality of lower layer measurements of the serving cell are measurements of a plurality of beams associated with the serving cell. In other of these embodiments, the offset is associated with an RRM A3 event and/or the second threshold is an S-Measure RRM threshold.

In some of these embodiments, the conditions include one or more of the following related to stopping or pausing lower layer measurements of at least one candidate cell:
results of the L3 measurements of the serving cell are above a fifth threshold;
results of the L3 measurements of the at least one candidate cell are below a sixth threshold;
one or more highest of a plurality of lower layer measurements of the serving cell are above an eighth threshold; and
one or more highest of a plurality of lower layer measurements of the at least one candidate cell are below a ninth threshold.

In some variants, the plurality of lower layer measurements of the at least one candidate cell (e.g., evaluated in relation to the ninth threshold) are measurements of a plurality of beams associated with the at least one candidate cell.

In some embodiments, the lower layer measurements of the serving cell and of the at least one candidate cell include one or more of the following: SS-RSRP, SS-RSRQ, SS-SINR, CSI-RSRP, CSI-RSRQ, CSI-SINR, L1-RSRP, L1-RSRQ, and L1-SINR.

In some embodiments, one or more of the following applies: the L3 measurements of the serving cell and of the at least one candidate cell are L3 reference signal received power (L3-RSRP) measurements; and the L3 measurements of the serving cell and of the at least one candidate cell are associated with L3 inter-cell mobility procedures (e.g., handover).

In some embodiments, the lower layer measurement report is a beam measurement report and/or the lower layer measurement report is received via a lower layer procedure on a PUCCH or a PUSCH in the serving cell. In some embodiments, the message that includes the configuration is an RRCReconfiguration message.

In some embodiments, the exemplary method can also include the operations of blocks 930-940, where based on the lower layer measurement report, the RAN node can select one of the candidate cells (i.e., having measurement results in the lower layer measurement report) for an L1/L2 inter-cell mobility procedure for the UE and send to the UE a lower layer message instructing the UE to perform the L1/L2 inter-cell mobility procedure to the selected candidate cell.

Although various embodiments are described above in terms of methods, techniques, and/or procedures, the person of ordinary skill will readily comprehend that such methods, techniques, and/or procedures can be embodied by various combinations of hardware and software in various systems, communication devices, computing devices, control devices, apparatuses, non-transitory computer-readable media, computer program products, etc.

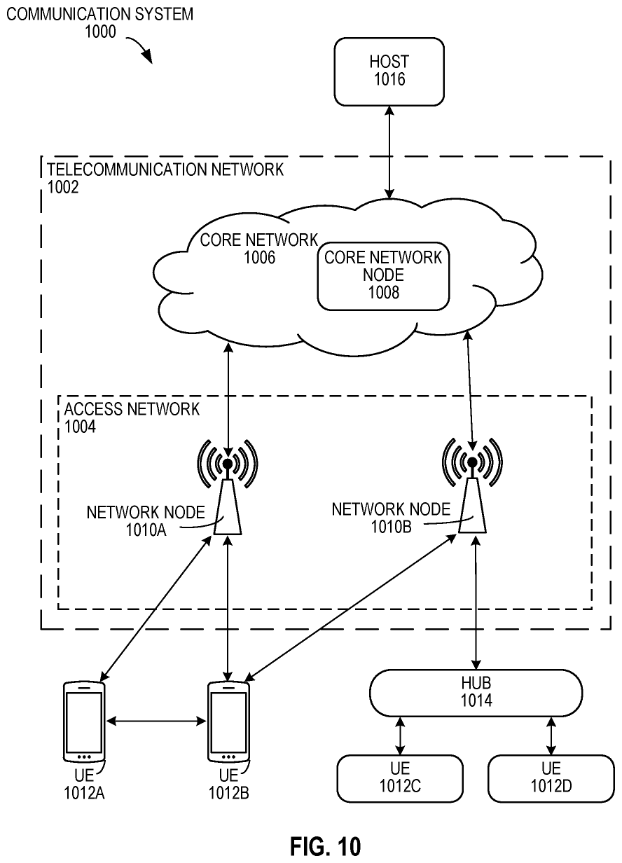

FIG. 10 shows an example of a communication system 1000 in accordance with some embodiments. In this example, communication system 1000 includes a telecommunication network 1002 that includes access network 1004 (e.g., RAN) and core network 1006, which includes one or more core network nodes 1008. Access network 1004 includes one or more access network nodes, such as network nodes 1010a-b (one or more of which may be generally referred to as network nodes 1010), or any other similar 3GPP access node or non-3GPP access point. Network nodes 1010 facilitate direct or indirect connection of UEs, such as by connecting UEs 1012a-d (one or more of which may be generally referred to as UEs 1012) to core network 1006 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, communication system 1000 may include any number of wired or wireless networks, network nodes, UEs, and/or any other components or systems that may facilitate or participate in the communication of data and/or signals whether via wired or wireless connections. Communication system 1000 may include and/or interface with any type of communication, telecommunication, data, cellular, radio network, and/or other similar type of system.

UEs 1012 may be any of a wide variety of communication devices, including wireless devices arranged, configured, and/or operable to communicate wirelessly with network nodes 1010 and other communication devices. Similarly, network nodes 1010 are arranged, capable, configured, and/or operable to communicate directly or indirectly with UEs 1012 and/or with other network nodes or equipment in telecommunication network 1002 to enable and/or provide network access, such as wireless network access, and/or to perform other functions, such as administration in telecommunication network 1002.

In the depicted example, core network 1006 connects network nodes 1010 to one or more hosts, such as host 1016. These connections may be direct or indirect via one or more intermediary networks or devices. In other examples, network nodes may be directly coupled to hosts. Core network 1006 includes one or more core network nodes (e.g., 1008) that are structured with hardware and software components. Features of these components may be substantially similar to those described with respect to the UEs, network nodes, and/or hosts, such that the descriptions thereof are generally applicable to the corresponding components of core network node 1008. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

Host 1016 may be under the ownership or control of a service provider other than an operator or provider of access network 1004 and/or telecommunication network 1002, and may be operated by the service provider or on behalf of the service provider. Host 1016 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, communication system 1000 of FIG. 10 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, telecommunication network 1002 is a cellular network that implements 3GPP standardized features. Accordingly, telecommunication network 1002 may support network slicing to provide different logical networks to different devices that are connected to telecommunication network 1002. For example, telecommunication network 1002 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, UEs 1012 are configured to transmit and/or receive information without direct human interaction. For instance, a UE may be designed to transmit information to access network 1004 on a predetermined schedule, when triggered by an internal or external event, or in response to requests from access network 1004. Additionally, a UE may be configured for operating in single- or multi-RAT or multi-standard mode. For example, a UE may operate with any one or combination of Wi-Fi, NR (New Radio) and LTE, i.e., being configured for multi-radio dual connectivity (MR-DC), such as E-UTRAN (Evolved-UMTS Terrestrial Radio Access Network) New Radio-Dual Connectivity (EN-DC).

In the example, hub 1014 communicates with access network 1004 to facilitate indirect communication between one or more UEs (e.g., 1012c and/or 1012d) and network nodes (e.g., 1010b). In some examples, hub 1014 may be a controller, router, content source and analytics, or any of the other communication devices described herein regarding UEs. For example, hub 1014 may be a broadband router enabling access to core network 1006 for the UEs. As another example, hub 1014 may be a controller that sends commands or instructions to one or more actuators in the UEs. Commands or instructions may be received from the UEs, network nodes 1010, or by executable code, script, process, or other instructions in hub 1014. As another example, hub 1014 may be a data collector that acts as temporary storage for UE data and, in some embodiments, may perform analysis or other processing of the data. As another example, hub 1014 may be a content source. For example, for a UE that is a VR headset, display, loudspeaker or other media delivery device, hub 1014 may retrieve VR assets, video, audio, or other media or data related to sensory information via a network node, which hub 1014 then provides to the UE either directly, after performing local processing, and/or after adding additional local content. In still another example, hub 1014 acts as a proxy server or orchestrator for the UEs, in particular in if one or more of the UEs are low energy IoT devices.

Hub 1014 may have a constant/persistent or intermittent connection to network node 1010b. Hub 1014 may also allow for a different communication scheme and/or schedule between hub 1014 and UEs (e.g., 1012c and/or 1012d), and between hub 1014 and core network 1006. In other examples, hub 1014 is connected to core network 1006 and/or one or more UEs via a wired connection. Moreover, hub 1014 may be configured to connect to an M2M service provider over access network 1004 and/or to another UE over a direct connection. In some scenarios, UEs may establish a wireless connection with network nodes 1010 while still connected via hub 1014 via a wired or wireless connection. In some embodiments, hub 1014 may be a dedicated hub—that is, a hub whose primary function is to route communications to/from the UEs from/to network node 1010b. In other embodiments, hub 1014 may be a non-dedicated hub—that is, a device which is capable of operating to route communications between the UEs and network node 1010b, but which is additionally capable of operating as a communication start and/or end point for certain data channels.

FIG. 11 shows a UE 1100 in accordance with some embodiments. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by 3GPP, including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

UE 1100 includes processing circuitry 1102 that is operatively coupled via bus 1104 to input/output interface 1106, power source 1108, memory 1110, communication interface 1112, and/or any other component, or any combination thereof. Certain UEs may utilize all or a subset of the components shown in FIG. 11. The level of integration between the components may vary from one UE to another UE. Further, certain UEs may contain multiple instances of a component, such as multiple processors, memories, transceivers, transmitters, receivers, etc.

Processing circuitry 1102 is configured to process instructions and data and may be configured to implement any sequential state machine operative to execute instructions stored as machine-readable computer programs in memory 1110. Processing circuitry 1102 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, processing circuitry 1102 may include multiple central processing units (CPUs).

In the example, input/output interface 1106 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into UE 1100. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, power source 1108 is structured as a battery or battery pack. Other types of power sources, such as an external power source (e.g., an electricity outlet), photovoltaic device, or power cell, may be used. Power source 1108 may further include power circuitry for delivering power from power source 1108 itself, and/or an external power source, to the various parts of UE 1100 via input circuitry or an interface such as an electrical power cable. Delivering power may be, for example, for charging power source 1108. Power circuitry may perform any formatting, converting, or other modification to the power from power source 1108 to make the power suitable for the respective components of UE 1100 to which power is supplied.

Memory 1110 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, memory 1110 includes one or more application programs 1114, such as an operating system, web browser application, a widget, gadget engine, or other application, and corresponding data 1116. Memory 1110 may store, for use by UE 1100, any of a variety of various operating systems or combinations of operating systems.

Memory 1110 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ Memory 1110 may allow UE 1100 to access instructions, application programs and the like, stored on transitory or non-transitory memory media, to off-load data, or to upload data. An article of manufacture, such as one utilizing a communication system may be tangibly embodied as or in memory 1110, which may be or comprise a device-readable storage medium.

Processing circuitry 1102 may be configured to communicate with an access network or other network using communication interface 1112. Communication interface 1112 may comprise one or more communication subsystems and may include or be communicatively coupled to antenna 1122. Communication interface 1112 may include one or more transceivers used to communicate, such as by communicating with one or more remote transceivers of another device capable of wireless communication (e.g., another UE or a network node in an access network). Each transceiver may include transmitter 1118 and/or receiver 1120 appropriate to provide network communications (e.g., optical, electrical, frequency allocations, and so forth). Moreover, transmitter 1118 and receiver 1120 may be coupled to one or more antennas (e.g., 1122) and may share circuit components, software, or firmware, or alternatively be implemented separately.

In the illustrated embodiment, communication functions of communication interface 1112 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through communication interface 1112, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., an alert is sent when moisture is detected), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to UE 1100 shown in FIG. 11.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to an individual use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator, and handle communication of data for both the speed sensor and the actuators.

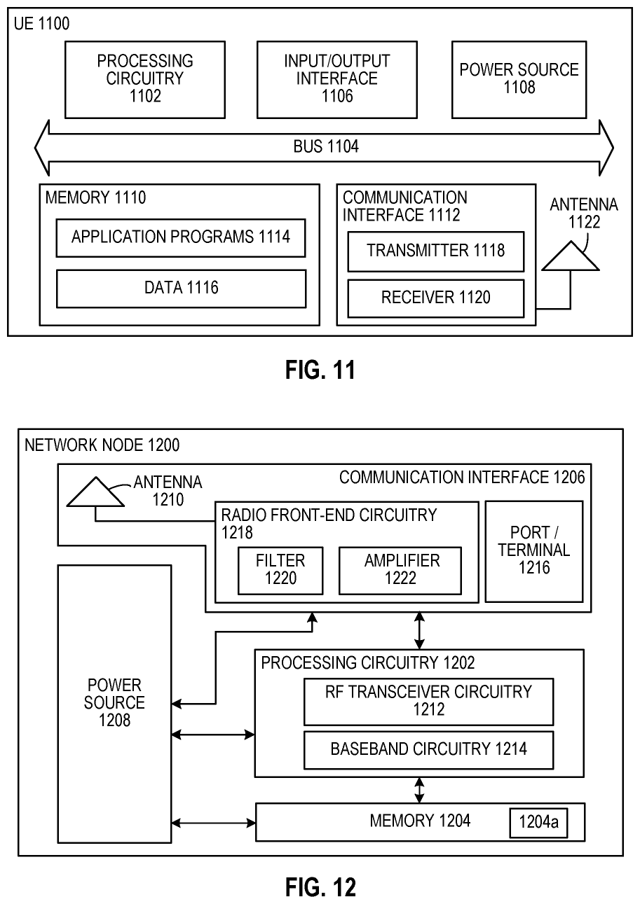

FIG. 12 shows a network node 1200 in accordance with some embodiments. Examples of network nodes include, but are not limited to, access points (e.g., radio access points) and base stations (e.g., radio base stations, Node Bs, eNBs, and gNBs).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

Network node 1200 includes processing circuitry 1202, memory 1204, communication interface 1206, and power source 1208. Network node 1200 may be composed of multiple physically separate components (e.g., a NodeB component and a RNC component, or a BTS component and a BSC component, etc.), which may each have their own respective components. In certain scenarios in which network node 1200 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, network node 1200 may be configured to support multiple radio access technologies (RATs). In such embodiments, some components may be duplicated (e.g., separate memory 1204 for different RATs) and some components may be reused (e.g., a same antenna 1210 may be shared by different RATs). Network node 1200 may also include multiple sets of the various illustrated components for different wireless technologies integrated into network node 1200, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1200.

Processing circuitry 1202 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1200 components, such as memory 1204, to provide network node 1200 functionality.

In some embodiments, processing circuitry 1202 includes a system on a chip (SOC). In some embodiments, processing circuitry 1202 includes one or more of radio frequency (RF) transceiver circuitry 1212 and baseband processing circuitry 1214. In some embodiments, RF transceiver circuitry 1212 and baseband processing circuitry 1214 may be on separate chips (or sets of chips), boards, or units, such as radio units and digital units. In alternative embodiments, part or all of RF transceiver circuitry 1212 and baseband processing circuitry 1214 may be on the same chip or set of chips, boards, or units.

Memory 1204 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by processing circuitry 1202. Memory 1204 may store any suitable instructions, data, or information, including a computer program, software, an application including one or more of logic, rules, code, tables, and/or other instructions (collectively denoted computer program 1204a, which may be in the form of a computer program product) capable of being executed by processing circuitry 1202 and utilized by network node 1200. Memory 1204 may be used to store any calculations made by processing circuitry 1202 and/or any data received via communication interface 1206. In some embodiments, processing circuitry 1202 and memory 1204 is integrated.

Communication interface 1206 is used in wired or wireless communication of signaling and/or data between a network node, access network, and/or UE. As illustrated, communication interface 1206 comprises port(s)/terminal(s) 1216 to send and receive data, for example to and from a network over a wired connection. Communication interface 1206 also includes radio front-end circuitry 1218 that may be coupled to, or in certain embodiments a part of, antenna 1210. Radio front-end circuitry 1218 comprises filters 1220 and amplifiers 1222. Radio front-end circuitry 1218 may be connected to an antenna 1210 and processing circuitry 1202. The radio front-end circuitry may be configured to condition signals communicated between antenna 1210 and processing circuitry 1202. Radio front-end circuitry 1218 may receive digital data that is to be sent out to other network nodes or UEs via a wireless connection. Radio front-end circuitry 1218 may convert the digital data into a radio signal having the appropriate channel and bandwidth parameters using a combination of filters 1220 and/or amplifiers 1222. The radio signal may then be transmitted via antenna 1210. Similarly, when receiving data, antenna 1210 may collect radio signals which are then converted into digital data by radio front-end circuitry 1218. The digital data may be passed to processing circuitry 1202. In other embodiments, the communication interface may comprise different components and/or different combinations of components.

In certain alternative embodiments, network node 1200 does not include separate radio front-end circuitry 1218, instead, processing circuitry 1202 includes radio front-end circuitry and is connected to antenna 1210. Similarly, in some embodiments, all or some of RF transceiver circuitry 1212 is part of communication interface 1206. In still other embodiments, communication interface 1206 includes one or more ports or terminals 1216, radio front-end circuitry 1218, and RF transceiver circuitry 1212, as part of a radio unit (not shown), and communication interface 1206 communicates with baseband processing circuitry 1214, which is part of a digital unit (not shown).

Antenna 1210 may include one or more antennas, or antenna arrays, configured to send and/or receive wireless signals. Antenna 1210 may be coupled to radio front-end circuitry 1218 and may be any type of antenna capable of transmitting and receiving data and/or signals wirelessly. In certain embodiments, antenna 1210 is separate from network node 1200 and connectable to network node 1200 through an interface or port.

Antenna 1210, communication interface 1206, and/or processing circuitry 1202 may be configured to perform any receiving operations and/or certain obtaining operations described herein as being performed by the network node. Any information, data and/or signals may be received from a UE, another network node and/or any other network equipment. Similarly, antenna 1210, communication interface 1206, and/or processing circuitry 1202 may be configured to perform any transmitting operations described herein as being performed by the network node. Any information, data and/or signals may be transmitted to a UE, another network node and/or any other network equipment.

Power source 1208 provides power to the various components of network node 1200 in a form suitable for the respective components (e.g., at a voltage and current level needed for each respective component). Power source 1208 may further comprise, or be coupled to, power management circuitry to supply the components of network node 1200 with power for performing the functionality described herein. For example, network node 1200 may be connectable to an external power source (e.g., the power grid, an electricity outlet) via an input circuitry or interface such as an electrical cable, whereby the external power source supplies power to power circuitry of power source 1208. As a further example, power source 1208 may comprise a source of power in the form of a battery or battery pack which is connected to, or integrated in, power circuitry. The battery may provide backup power should the external power source fail.

Embodiments of network node 1200 may include additional components beyond those shown in FIG. 12 for providing certain aspects of the network node's functionality, including any of the functionality described herein and/or any functionality necessary to support the subject matter described herein. For example, network node 1200 may include user interface equipment to allow input of information into network node 1200 and to allow output of information from network node 1200. This may allow a user to perform diagnostic, maintenance, repair, and other administrative functions for network node 1200.

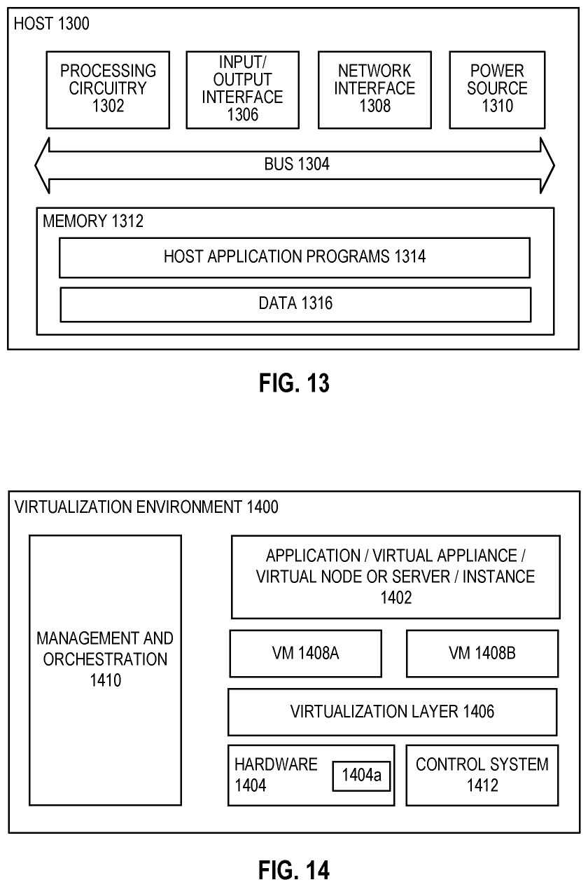

FIG. 13 is a block diagram of a host 1300, which may be an embodiment of host 1016 of FIG. 10, in accordance with various aspects described herein. As used herein, host 1300 may be or comprise various combinations hardware and/or software, including standalone server, blade server, cloud-implemented server, distributed server, virtual machine, container, or processing resources in a server farm. Host 1300 may provide one or more services to one or more UEs. Host 1300 includes processing circuitry 1302 that is operatively coupled via bus 1304 to input/output interface 1306, network interface 1308, power source 1310, and memory 1312. Other components may be included in other embodiments. Features of these components may be substantially similar to those described with respect to the devices of previous figures, such as FIGS. 11 and 12, such that the descriptions thereof are generally applicable to the corresponding components of host 1300.

Memory 1312 may include one or more computer programs including one or more host application programs 1314 and data 1316, which may include user data, e.g., data generated by a UE for host 1300 or data generated by host 1300 for a UE. Embodiments of host 1300 may utilize only a subset or all of the components shown. Host application programs 1314 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). Host application programs 1314 may also provide for user authentication and licensing checks and may periodically report health, routes, and content availability to a central node, such as a device in or on the edge of a core network. Accordingly, host 1300 may select and/or indicate a different host for over-the-top services for a UE. Host application programs 1314 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 14 is a block diagram illustrating a virtualization environment 1400 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1400 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1402 (which may alternatively be called software instances, virtual appliances, network functions, virtual nodes, virtual network functions, etc.) are run in the virtualization environment 1400 to implement some of the features, functions, and/or benefits of some of the embodiments disclosed herein.

Hardware 1404 includes processing circuitry, memory that stores software and/or instructions (collectively denoted computer program 1404a, which may be in the form of a computer program product) executable by hardware processing circuitry, and/or other hardware devices as described herein, such as a network interface, input/output interface, and so forth. Software may be executed by the processing circuitry to instantiate one or more virtualization layers 1406 (also referred to as hypervisors or virtual machine monitors (VMMs)), provide VMs 1408a-b (one or more of which may be generally referred to as VMs 1408), and/or perform any of the functions, features and/or benefits described in relation with some embodiments described herein. Virtualization layer 1406 may present a virtual operating platform that appears like networking hardware to VMs 1408.

VMs 1408 comprise virtual processing, virtual memory, virtual networking or interface and virtual storage, and may be run by a corresponding virtualization layer 1406. Different embodiments of virtual appliance 1402 may be implemented on one or more of VMs 1408, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, each VM 1408 may be a software implementation of a physical machine that runs programs as if they were executing on a physical, non-virtualized machine. Each VM 1408, and that part of hardware 1404 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1408 on top of the hardware 1404 and corresponds to application 1402.

Hardware 1404 may be implemented in a standalone network node with generic or specific components. Hardware 1404 may implement some functions via virtualization. Alternatively, hardware 1404 may be part of a larger cluster of hardware (e.g., such as in a data center or CPE) where many hardware nodes work together and are managed via management and orchestration 1410, which, among others, oversees lifecycle management of applications 1402. In some embodiments, hardware 1404 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1412 which may alternatively be used for communication between hardware nodes and radio units.

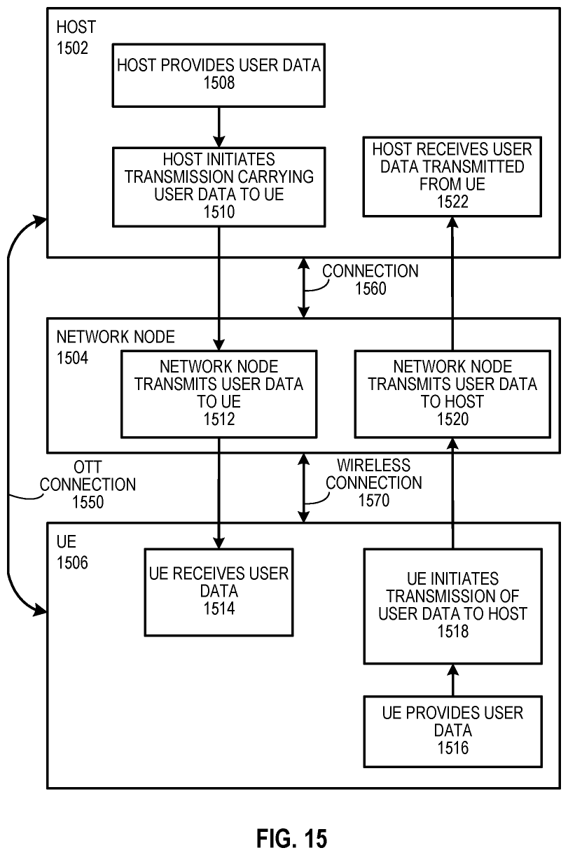

FIG. 15 shows a communication diagram of a host 1502 communicating via a network node 1504 with a UE 1506 over a partially wireless connection in accordance with some embodiments. Example implementations, in accordance with various embodiments, of the UE (such as a UE 1012a of FIG. 10 and/or UE 1100 of FIG. 11), network node (such as network node 1010a of FIG. 10 and/or network node 1200 of FIG. 12), and host (such as host 1016 of FIG. 10 and/or host 1300 of FIG. 13) discussed in the preceding paragraphs will now be described with reference to FIG. 15.

Like host 1300, embodiments of host 1502 include hardware, such as a communication interface, processing circuitry, and memory. Host 1502 also includes software, which is stored in or accessible by host 1502 and executable by the processing circuitry. The software includes a host application that may be operable to provide a service to a remote user, such as UE 1506 connecting via an over-the-top (OTT) connection 1550 extending between UE 1506 and host 1502. In providing the service to the remote user, a host application may provide user data which is transmitted using OTT connection 1550.

Network node 1504 includes hardware enabling it to communicate with host 1502 and UE 1506. Connection 1560 may be direct or pass through a core network (like core network 1006 of FIG. 10) and/or one or more other intermediate networks, such as one or more public, private, or hosted networks. For example, an intermediate network may be a backbone network or the Internet.

UE 1506 includes hardware and software, which is stored in or accessible by UE 1506 and executable by the UE's processing circuitry. The software includes a client application, such as a web browser or operator-specific “app” that may be operable to provide a service to a human or non-human user via UE 1506 with the support of host 1502. In host 1502, an executing host application may communicate with the executing client application via OTT connection 1550 terminating at UE 1506 and host 1502. In providing the service to the user, the UE's client application may receive request data from the host's host application and provide user data in response to the request data. OTT connection 1550 may transfer both the request data and the user data. The UE's client application may interact with the user to generate the user data that it provides to the host application through OTT connection 1550.

OTT connection 1550 may extend via connection 1560 between host 1502 and network node 1504 and via wireless connection 1570 between network node 1504 and UE 1506 to provide the connection between host 1502 and UE 1506. Connection 1560 and wireless connection 1570, over which OTT connection 1550 may be provided, have been drawn abstractly to illustrate the communication between host 1502 and UE 1506 via network node 1504, without explicit reference to any intermediary devices and the precise routing of messages via these devices.

As an example of transmitting data via OTT connection 1550, in step 1508, host 1502 provides user data, which may be performed by executing a host application. In some embodiments, the user data is associated with a particular human user interacting with UE 1506. In other embodiments, the user data is associated with a UE 1506 that shares data with host 1502 without explicit human interaction. In step 1510, host 1502 initiates a transmission carrying the user data towards UE 1506. Host 1502 may initiate the transmission responsive to a request transmitted by UE 1506. The request may be caused by human interaction with UE 1506 or by operation of the client application executing on UE 1506. The transmission may pass via network node 1504, in accordance with the teachings of the embodiments described throughout this disclosure. Accordingly, in step 1512, network node 1504 transmits to UE 1506 the user data that was carried in the transmission that host 1502 initiated, in accordance with the teachings of the embodiments described throughout this disclosure. In step 1514, UE 1506 receives the user data carried in the transmission, which may be performed by a client application executed on UE 1506 associated with the host application executed by host 1502.

In some examples, UE 1506 executes a client application which provides user data to host 1502. The user data may be provided in reaction or response to the data received from host 1502. Accordingly, in step 1516, UE 1506 may provide user data, which may be performed by executing the client application. In providing the user data, the client application may further consider user input received from the user via an input/output interface of UE 1506. Regardless of how the user data was provided, UE 1506 initiates, in step 1518, transmission of the user data towards host 1502 via network node 1504. In step 1520, in accordance with the teachings of the embodiments described throughout this disclosure, network node 1504 receives user data from UE 1506 and initiates transmission of the received user data towards host 1502. In step 1522, host 1502 receives the user data carried in the transmission initiated by UE 1506.

One or more of the various embodiments improve the performance of OTT services provided to UE 1506 using OTT connection 1550, in which wireless connection 1570 forms the last segment. More precisely, compared to conventional techniques in which UEs autonomously select a subset M<N of configured candidate cells for measuring and reporting, embodiments enable the UE to systematically select a subset of candidate cells that is optimal and/or preferred at any given time. In this manner, lower layer measurements reported by the UE are better and/or more relevant for beam management and/or L1/L2 inter-cell mobility, while avoiding excessive UE energy consumption due to unnecessary measurements. By improving operation of UEs and RANs in this manner, embodiments increase the value of OTT services delivered via the RAN to UEs, to both end users and service providers.

In an example scenario, factory status information may be collected and analyzed by host 1502. As another example, host 1502 may process audio and video data which may have been retrieved from a UE for use in creating maps. As another example, host 1502 may collect and analyze real-time data to assist in controlling vehicle congestion (e.g., controlling traffic lights).

As another example, host 1502 may store surveillance video uploaded by a UE. As another example, host 1502 may store or control access to media content such as video, audio, VR or AR which it can broadcast, multicast or unicast to UEs. As other examples, host 1502 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring OTT connection 1550 between host 1502 and UE 1506, in response to variations in the measurement results. The measurement procedure and/or the network functionality for reconfiguring the OTT connection may be implemented in software and hardware of host 1502 and/or UE 1506. In some embodiments, sensors (not shown) may be deployed in or in association with other devices through which OTT connection 1550 passes; the sensors may participate in the measurement procedure by supplying values of the monitored quantities exemplified above, or supplying values of other physical quantities from which software may compute or estimate the monitored quantities. Reconfiguring OTT connection 1550 may include message format, retransmission settings, preferred routing etc.; the reconfiguration need not directly alter the operation of network node 1504. Such procedures and functionalities may be known and practiced in the art. In certain embodiments, measurements may involve proprietary UE signaling that facilitates measurements of throughput, propagation times, latency and the like, by host 1502. The measurements may be implemented in that software causes messages to be transmitted, in particular empty or “dummy” messages, using OTT connection 1550 while monitoring propagation times, errors, etc.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures that, although not explicitly shown or described herein, embody the principles of the disclosure and can be thus within the spirit and scope of the disclosure. Various embodiments can be used together with one another, as well as interchangeably therewith, as should be understood by those having ordinary skill in the art.

The term unit, as used herein, can have conventional meaning in the field of electronics, electrical devices and/or electronic devices and can include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for performing one or more of the techniques described herein. In some implementations, the processing circuitry may be used to cause the respective functional unit to perform corresponding functions according to one or more embodiments of the present disclosure.

As described herein, device and/or apparatus can be represented by a semiconductor chip, a chipset, or a (hardware) module comprising such chip or chipset; this, however, does not exclude the possibility that a functionality of a device or apparatus, instead of being hardware implemented, be implemented as a software module such as a computer program or a computer program product comprising executable software code portions for execution or being run on a processor. Furthermore, functionality of a device or apparatus can be implemented by any combination of hardware and software. A device or apparatus can also be regarded as an assembly of multiple devices and/or apparatuses, whether functionally in cooperation with or independently of each other. Moreover, devices and apparatuses can be implemented in a distributed fashion throughout a system, so long as the functionality of the device or apparatus is preserved. Such and similar principles are considered as known to a skilled person.

Furthermore, functions described herein as being performed by a wireless device or a network node may be distributed over a plurality of wireless devices and/or network nodes. In other words, it is contemplated that the functions of a network node and a wireless device described herein are not limited to performance by a single physical device and, in fact, can be distributed among several physical devices.

In addition, certain terms used in the present disclosure, including the specification and drawings, can be used synonymously in certain instances (e.g., “data” and “information”). It should be understood, that although these terms (and/or other terms that can be synonymous to one another) can be used synonymously herein, there can be instances when such words can be intended to not be used synonymously.

The techniques and apparatus described herein include, but are not limited to, the following enumerated examples:

A1. A method for a user equipment (UE) configured to communicate with a radio access network (RAN) node via a serving cell, the method comprising:
receiving, from the RAN node, a message that includes a configuration for lower layer measurements by the UE, wherein the configuration includes one or more conditions for lower layer measurements on one or more candidate cells for L1/L2 inter-cell mobility;
performing one or more of the following measurements: lower layer measurements of the serving cell, first layer-3 (L3) measurements of the serving cell, and second L3 measurements of at least one of the candidate cells;
based on detecting that the performed measurements fulfil at least one of the conditions, initiating lower layer measurements of at least one candidate cell associated with the fulfilled at least one condition;
sending, to the RAN node, a lower layer measurement report that includes results of the lower layer measurements performed on the at least one candidate cell.
   A2. The method of embodiment A1, wherein detecting that the performed measurements fulfill at least one of the conditions includes detecting one or more of the following:
results of the lower layer measurements of the serving cell are below a first threshold;
results of the L3 measurements of the serving cell are below a second threshold;
results of the L3 measurements of a candidate cell are below a third threshold;
results of the L3 measurements of a candidate cell are at least an offset greater than results of the L3 measurements of the serving cell;
results of the L3 measurements of the serving cell are below a fourth threshold; and one or more highest of a plurality of lower layer measurements of the serving cell are below a seventh threshold.
   A3. The method of embodiment A2, wherein the plurality of lower layer measurements of the serving cell are measurements of a plurality of beams associated with the serving cell.
   A3a. The method of embodiment A2, wherein one or more of the following applies:
the offset is associated with a radio resource management (RRM) A3 event; and
the second threshold is an S-Measure RRM threshold.
   A4. The method of any of embodiments A1-A3a, further comprising stopping or pausing the lower layer measurements of the at least one candidate cell based on detecting that at least one of the following measurements fulfills a further one or more of the conditions:
the lower layer measurements of the at least one candidate cell,
the lower layer measurements of the serving cell,
the first L3 measurements of the serving cell, and
the second L3 measurements of the at least one of the candidate cell
   A5. The method of embodiment A4, wherein detecting that at least one the measurement fulfills a further one or more of the conditions includes detecting any of the following:
results of the L3 measurements of the serving cell are above a fifth threshold;
results of the L3 measurements of the at least one candidate cell are below a sixth threshold;
one or more highest of a plurality of lower layer measurements of the serving cell are above an eighth threshold; and
one or more highest of a plurality of lower layer measurements of the at least one candidate cell are below a ninth threshold.
   A5a. The method of embodiment A5, wherein the plurality of lower layer measurements of the at least one candidate cell are measurements of a plurality of beams associated with the at least one candidate cell.
   A6. The method of any of embodiments A1-A5a, wherein the lower layer measurements of the serving cell and of the at least one candidate cell include one or more of the following: synchronization signal/PBCH (SSB) reference signal received power (SS-RSRP), SSB reference signal received quality (SS-RSRQ), SSB signal-to-noise and interference ratio (SS-SINR), channel state information (CSI) reference signal received power (CSI-RSRP), CSI reference signal received quality (CSI-RSRQ), CSI signal-to-noise and interference ratio (CSI-SINR), L1-RSRP, L1-RSRQ, and L1-SINR.
   A7. The method of any of embodiments A1-A6, wherein one or more of the following applies:
the L3 measurements of the serving cell and of the at least one candidate cell are L3 reference signal received power (L3-RSRP) measurements; and
the L3 measurements of the serving cell and of the at least one candidate cell are associated with L3 inter-cell mobility procedures.
   A8. The method of any of embodiments A1-A7, wherein:
the one or more candidate cells for L1/L2 inter-cell mobility include a plurality of candidate cells;
the method further comprises:
   determining that a plurality of the candidate cell are associated with the fulfilled at least one condition; and
   selecting a subset of the plurality of candidate cells based on results of the respective second L3 measurements of the plurality of candidate cells; and
the lower layer measurements are initiated for the selected subset.
   A9. The method of any of embodiments A1-A8, wherein one or more of the following applies:
the lower layer measurement report is a beam measurement report; and
the lower layer measurement report is sent via a lower layer procedure on a Physical Uplink Control Channel (PUCCH) or a Physical Uplink Shared Channel (PUSCH) in the serving cell.
   A10. The method of any of embodiments A1-A9, wherein the message that includes the configuration is an RRCReconfiguration message.
   A11. The method of any of embodiments A1-A10, further comprising receiving, from the RAN node, a lower layer message instructing the UE to perform an L1/L2 inter-cell mobility procedure to one of the candidate cells for which measurement results were included in the lower layer measurement report.
   B1. A method for a radio access network (RAN) node configured to provide a serving cell to user equipment (UEs), the method comprising:
sending, to a UE, a message that includes a configuration for lower layer measurements by the UE, wherein the configuration includes one or more conditions for lower layer measurements on one or more candidate cells for L1/L2 inter-cell mobility, wherein the conditions are based on one or more of the following: lower layer measurements of the serving cell, first layer-3 (L3) measurements of the serving cell, and second L3 measurements of at least one of the candidate cells; and
receiving, from the UE, a lower layer measurement report that includes results of the lower layer measurements performed on the at least one candidate cell, based on fulfilment of at least one of the conditions.
   B2. The method of embodiment B1, wherein the conditions include one or more of the following:
results of the lower layer measurements of the serving cell are below a first threshold;
results of the L3 measurements of the serving cell are below a second threshold;
results of the L3 measurements of a candidate cell are below a third threshold;
results of the L3 measurements of a candidate cell are at least an offset greater than results of the L3 measurements of the serving cell;
results of the L3 measurements of the serving cell are below a fourth threshold; and
one or more highest of a plurality of lower layer measurements of the serving cell are below a seventh threshold.
   B3. The method of embodiment B2, wherein the plurality of lower layer measurements of the serving cell are measurements of a plurality of beams associated with the serving cell.
   B4. The method of embodiment B2, wherein one or more of the following applies:
the offset is associated with an A3 RRM event; and
the second threshold is an S-Measure radio resource management (RRM) threshold.
   B5. The method of any of embodiments B1-B4, wherein the conditions include one or more of the following related to stopping or pausing lower layer measurements of at least one candidate cell:
results of the L3 measurements of the serving cell are above a fifth threshold;
results of the L3 measurements of the at least one candidate cell are below a sixth threshold;
one or more highest of a plurality of lower layer measurements of the serving cell are above an eighth threshold; and
one or more highest of a plurality of lower layer measurements of the at least one candidate cell are below a ninth threshold.
   B5a. The method of embodiment B5, wherein the plurality of lower layer measurements of the at least one candidate cell are measurements of a plurality of beams associated with the at least one candidate cell.
   B6. The method of any of embodiments B1-B5a, wherein the lower layer measurements of the serving cell and of the at least one candidate cell include one or more of the following: synchronization signal/PBCH (SSB) reference signal received power (SS-RSRP), SSB reference signal received quality (SS-RSRQ), SSB signal-to-noise and interference ratio (SS-SINR), channel state information (CSI) reference signal received power (CSI-RSRP), CSI reference signal received quality (CSI-RSRQ), CSI signal-to-noise and interference ratio (CSI-SINR), L1-RSRP, L1-RSRQ, and L1-SINR.
   B7. The method of any of embodiments B1-B6, wherein one or more of the following applies:
the L3 measurements of the serving cell and of the at least one candidate cell are L3 reference signal received power (L3-RSRP) measurements; and
the L3 measurements of the serving cell and of the at least one candidate cell are associated with L3 inter-cell mobility procedures.
   B8. The method of any of embodiments B1-B7, wherein one or more of the following applies:
the lower layer measurement report is a beam measurement report; and
the lower layer measurement report is received via a lower layer procedure on a Physical Uplink Control Channel (PUCCH) or a Physical Uplink Shared Channel (PUSCH) in the serving cell.
   B9. The method of any of embodiments B1-B8, wherein the message that includes the configuration is an RRCReconfiguration message.
   B10. The method of any of embodiments B1-B9, further comprising:
based on the lower layer measurement report, selecting one of the candidate cells for an L1/L2 inter-cell mobility procedure for the UE; and
sending to the UE a lower layer message instructing the UE to perform the L1/L2 inter-cell mobility procedure to the selected candidate cell.
   C1. A user equipment (UE) configured to communicate with a radio access network (RAN) node via a serving cell, the UE comprising:
communication interface circuitry configured to communicate with the RAN node via the serving cell; and
processing circuitry operably coupled to the communication interface circuitry, wherein the processing circuitry and communication interface circuitry are further configured to perform operations corresponding to any of the methods of embodiments A1-A10.
   C2. A user equipment (UE) configured to communicate with a radio access network (RAN) node via a serving cell, the UE being further configured to perform operations corresponding to any of the methods of embodiments A1-A10.
   C3. A non-transitory, computer-readable medium storing computer-executable instructions that, when executed by processing circuitry of a user equipment (UE) configured to communicate with a radio access network (RAN) node via a serving cell, configure the UE to perform operations corresponding to any of the methods of embodiments A1-A10.
   C4. A computer program product comprising computer-executable instructions that, when executed by processing circuitry of a user equipment (UE) configured to communicate with a radio access network (RAN) node via a serving cell, configure the UE to perform operations corresponding to any of the methods of embodiments A1-A10.
   D1. A radio access network (RAN) node configured to provide a serving cell to user equipment (UEs), the RAN node comprising:
communication interface circuitry configured to communicate with UEs via the serving cell; and
processing circuitry operably coupled to the communication interface circuitry, whereby the processing circuitry and the communication interface circuitry are configured to perform operations corresponding to any of the methods of embodiments B1-B8.
   D2. A radio access network (RAN) node configured to provide a serving cell to user equipment (UEs), the RAN node being further configured to perform operations corresponding to any of the methods of embodiments B1-B8.
   D3. A non-transitory, computer-readable medium storing computer-executable instructions that, when executed by processing circuitry of a radio access network (RAN) node configured to provide a serving cell to user equipment (UEs), configure the RAN node to perform operations corresponding to any of the methods of embodiments B1-B8.
   D4. A computer program product comprising computer-executable instructions that, when executed by processing circuitry of a radio access network (RAN) node configured to provide a serving cell to user equipment (UEs), configure the RAN node to perform operations corresponding to any of the methods of embodiments B1-B8.

1.-38. (canceled)

39. A method for a user equipment (UE) configured to communicate with a radio access network (RAN) node via a serving cell, the method comprising:
obtaining a configuration that defines one or more conditions that trigger lower layer measurements on one or more candidate cells for layer-1/layer-2 (L1/L2) inter-cell mobility;
performing first layer-3 (L3) measurements of the serving cell, based on detecting that the performed measurements fulfil at least one of the one or more conditions, initiating lower layer measurements of at least one candidate cell associated with the fulfilled at least one condition; and
sending, to the RAN node, a lower layer measurement report that includes results of the lower layer measurements performed on the at least one candidate cell.

40. The method of claim 39, wherein detecting that the performed measurements fulfill at least one of the one or more conditions includes detecting that the results of the L3 measurements of the serving cell are below an S-Measure radio resource management (RRM) threshold.

41. The method of claim 39, wherein the lower layer measurements of the serving cell and of the at least one candidate cell include one or more of the following:
synchronization signal/PBCH (SSB) reference signal received power (SS-RSRP);
SSB reference signal received quality (SS-RSRQ);
SSB signal-to-noise and interference ratio (SS-SINR);
channel state information (CSI) reference signal received power (CSI-RSRP);
CSI reference signal received quality (CSI-RSRQ);
CSI signal-to-noise and interference ratio (CSI-SINR);
layer 1 reference signal received power (L1-RSRP);
layer 1 reference signal received quality (L1-RSRQ); and
layer 1 signal-to-noise and interference ratio (L1-SINR).

42. The method of claim 39, wherein one or more of the following applies:
the L3 measurements of the serving cell and of the at least one candidate cell are L3 reference signal received power (L3-RSRP) measurements; and
the L3 measurements of the serving cell and of the at least one candidate cell are associated with L3 inter-cell mobility procedures.

43. The method of claim 39, wherein:
the one or more candidate cells for L1/L2 inter-cell mobility include a plurality of candidate cells;
detecting that the performed measurements fulfil at least one of the conditions comprises determining that a plurality of the candidate cell are associated with the fulfilled at least one condition; and
initiating lower layer measurements of at least one candidate cell associated with the fulfilled at least one condition selecting a subset of the plurality of candidate cells based on results of the respective second L3 measurements of the plurality of candidate cells, wherein the lower layer measurements are initiated for the selected subset.

44. The method of claim 39, wherein one or more of the following applies:
the lower layer measurement report is a beam measurement report; and
the lower layer measurement report is sent via a lower layer procedure on a Physical Uplink Control Channel (PUCCH) or a Physical Uplink Shared Channel (PUSCH) in the serving cell.

45. The method of claim 39, wherein obtaining the configuration comprises receiving from the RAN node an RRCReconfiguration message that includes the configuration or a portion thereof.

46. The method of claim 39, wherein the configuration, or a portion thereof, is obtained from UE memory.

47. The method of claim 39, further comprising receiving, from the RAN node, a lower layer message instructing the UE to perform an L1/L2 inter-cell mobility procedure to one of the candidate cells for which measurement results were included in the lower layer measurement report.

48. A method for a radio access network (RAN) node configured to provide a serving cell to user equipment (UEs), the method comprising:
sending, to a UE, a configuration that defines one or more conditions that trigger lower layer measurements on one or more candidate cells for layer-1/layer-2, (L1/L2) inter-cell mobility, wherein the one or more conditions are based on first layer-3 (L3) measurements of the serving cell; and
receiving, from the UE, a lower layer measurement report that includes results of the lower layer measurements performed on the at least one candidate cell, based on fulfilment of at least one of the one or more conditions.

49. The method of claim 48, wherein the one or more conditions include results of the L3 measurements of the serving cell being below an S-Measure RRM threshold.

50. The method of claim 48, wherein the lower layer measurements of the serving cell and of the at least one candidate cell include one or more of the following:
synchronization signal/PBCH (SSB) reference signal received power (SS-RSRP);
SSB reference signal received quality (SS-RSRQ);
SSB signal-to-noise and interference ratio (SS-SINR);
channel state information (CSI) reference signal received power (CSI-RSRP);
CSI reference signal received quality (CSI-RSRQ);
CSI signal-to-noise and interference ratio (CSI-SINR);
layer 1 reference signal received power (L1-RSRP);
layer 1 reference signal received quality (L1-RSRQ); and
layer 1 signal-to-noise and interference ratio (L1-SINR).

51. The method of claim 48, wherein one or more of the following applies:
the L3 measurements of the serving cell and of the at least one candidate cell are L3 reference signal received power (L3-RSRP) measurements; and
the L3 measurements of the serving cell and of the at least one candidate cell are associated with L3 inter-cell mobility procedures.

52. The method of claim 48, wherein one or more of the following applies:
the lower layer measurement report is a beam measurement report; and
the lower layer measurement report is received via a lower layer procedure on a Physical Uplink Control Channel (PUCCH) or a Physical Uplink Shared Channel (PUSCH) in the serving cell.

53. The method of claim 48, wherein the configuration is included in an RRCReconfiguration message sent to the UE.

54. The method of claim 48, further comprising:
based on the lower layer measurement report, selecting one of the candidate cells for an L1/L2 inter-cell mobility procedure for the UE; and
sending to the UE a lower layer message instructing the UE to perform the L1/L2 inter-cell mobility procedure to the selected candidate cell.

55. A user equipment (UE) comprising:
communication interface circuitry configured to communicate with a radio access network (RAN) node via a serving cell; and
processing circuitry operably coupled to the communication interface circuitry, wherein the processing circuitry and communication interface circuitry are configured to:
obtain a configuration that defines one or more conditions that trigger lower layer measurements on one or more candidate cells for layer-1/layer-2 (L1/L2) inter-cell mobility;
perform first layer-3 (L3) measurements of the serving cell,
based on detecting that the performed measurements fulfil at least one of the one or more conditions, initiate lower layer measurements of at least one candidate cell associated with the fulfilled at least one condition; and
send, to the RAN node, a lower layer measurement report that includes results of the lower layer measurements performed on the at least one candidate cell.

56. The UE of claim 55, wherein the processing circuitry and communication interface circuitry are configured to detect that the performed measurements fulfill at least one of the one or more conditions based on detecting that the results of the L3 measurements of the serving cell are below an S-Measure radio resource management (RRM) threshold.

57. The UE of claim 55, wherein:
the one or more candidate cells for L1/L2 inter-cell mobility include a plurality of candidate cells;
the processing circuitry and communication interface circuitry are configured to detect that the performed measurements fulfil at least one of the one or more conditions based on determining that a plurality of the candidate cell are associated with the fulfilled at least one condition; and
the processing circuitry and communication interface circuitry are configured to initiate lower layer measurements of at least one candidate cell associated with the fulfilled at least one condition based on selecting a subset of the plurality of candidate cells based on results of the respective second L3 measurements of the plurality of candidate cells, wherein the lower layer measurements are initiated for the selected subset.

58. A radio access network (RAN) node comprising:
communication interface circuitry configured to communicate with user equipment (UEs) via a serving cell; and
processing circuitry operably coupled to the communication interface circuitry, wherein the processing circuitry and the communication interface circuitry are configured to:
send, to a UE, a configuration that defines one or more conditions that trigger lower layer measurements on one or more candidate cells for layer-1/layer-2, (L1/L2) inter-cell mobility, wherein the one or more conditions are based on first layer-3 (L3) measurements of the serving cell; and
receive, from the UE, a lower layer measurement report that includes results of the lower layer measurements performed on the at least one candidate cell, based on fulfilment of at least one of the one or more conditions.

59. The RAN node of claim 58, wherein the one or more conditions include results of the L3 measurements of the serving cell being below an S-Measure radio resource management (RRM) threshold.

60. The RAN node of claim 58, wherein the processing circuitry and the communication interface circuitry are further configured to:
based on the lower layer measurement report, select one of the candidate cells for an L1/L2 inter-cell mobility procedure for the UE; and
send to the UE a lower layer message instructing the UE to perform the L1/L2 inter-cell mobility procedure to the selected candidate cell.
